(19) United States
(12) Patent Application Publication
(10) Pub. No.: US 2026/0131480 A1
(43) Pub. Date: May 14, 2026

(54) ADJUSTABLE END-OF-ARM TOOL OR FIXTURE

(71) Applicant: Magswitch Automation Company, Superior, CO (US)

(72) Inventors: David H. Morton, Boulder, CO (US); Cengiz Kizilkan, Ingolstadt (DE)

(21) Appl. No.: 19/361,844

(22) Filed: Oct. 17, 2025

Related U.S. Application Data
(63) Continuation of application No. 18/568,736, now Pat. No. 12,472,642.
(60) Provisional application No. 63/209,878, filed on Jun. 11, 2021.

(51) Int. Cl. B25J 15/00; B25J 9/16; B25J 15/06

(52) U.S. Cl. CPC B25J 15/0004; B25J 9/1612; B25J 9/1664; B25J 9/1697; B25J 15/0052; B25J 15/0608

(57) ABSTRACT

Adjustable end of arm tools for robots and fixtures are disclosed. The adjustable end of arm tools and fixtures may each have multiple degrees of freedom to position an interface of a tool in one of a plurality of configurations.

### RELATED APPLICATION

This application is a continuation application of U.S. application Ser. No. 18/568,736, filed Dec. 8, 2023, titled ADJUSTABLE END-OF-ARM TOOL OR FIXTURE, which is a national stage application of PCT International Application No. PCT/US2022/033154, filed Jun. 11, 2022, titled ADJUSTABLE END-OF-ARM TOOL OR FIXTURE, which claims the benefit of U.S. Provisional Application No. 63/209,878, filed Jun. 11, 2021, titled ADJUSTABLE END-OF-ARM TOOL OR FIXTURE, the entire disclosures of which are expressly incorporated by reference herein.

### BACKGROUND

An end-of-arm tool may be used to manipulate an object or a fixture may be used to support an object. However, such devices and fixtures are typically designed for a specific object, such that manipulating or supporting different objects entails substituting an end-of-arm tool or fixture with another specialized device or fixture. Such specialization may introduce manufacturing delays (e.g., as a result of the time required to switch devices and fixtures), lead to additional complexity (e.g., to plan and program changes), and require additional space (e.g., to store multiple devices and use multiple fixtures).

It is with respect to these and other general considerations that embodiments have been described. Also, although relatively specific problems have been discussed, it should be understood that the embodiments should not be limited to solving the specific problems identified in the background.

### SUMMARY

In an exemplary embodiment of the present disclosure, an adjustable end-of-arm tool for a robot is provided. The adjustable end-of-arm tool comprising a base adapted to be coupled to the robot; a first adjustable assembly coupled to the base; and a second adjustable assembly coupled to the base. The first adjustable assembly comprising: a first plurality of links; a first plurality of couplers coupling the plurality of links and the base, the first plurality of couplers providing at least two degrees of the freedom; and a first tool coupled to the base through the first plurality of links and the first plurality of couplers, the first tool including a first interface which is positionable relative to the base in multiple positions based on the first plurality of links and the first plurality of couplers. The second adjustable assembly comprising: a second plurality of links; a second plurality of couplers coupling the plurality of links and the base, the first plurality of couplers providing at least two degrees of the freedom; and a second tool coupled to base through the second plurality of links and the second plurality of couplers, the second tool including a second interface which is positionable relative to the base in multiple positions based on the second plurality of links and the second plurality of couplers.

In another exemplary embodiment of the present disclosure, an adjustable fixture to receive an object is provided. The adjustable fixture comprising: a base; a first adjustable assembly coupled to the base; and a second adjustable assembly coupled to the base. The first adjustable assembly comprising: a first plurality of links; a first plurality of couplers coupling the plurality of links and the base, the first plurality of couplers providing at least two degrees of the freedom; and a first tool coupled to the base through the first plurality of links and the first plurality of couplers. The first tool including a first interface extending above the base. The first interface being positionable relative to the base in multiple positions based on the first plurality of links and the first plurality of couplers. The second adjustable assembly comprising: a second plurality of links; a second plurality of couplers coupling the plurality of links and the base, the first plurality of couplers providing at least two degrees of the freedom; and a second tool coupled to base through the second plurality of links and the second plurality of couplers. The second tool including a second interface extending above the base. The second interface being positionable relative to the base in multiple positions based on the second plurality of links and the second plurality of couplers.

In a further exemplary embodiment of the present disclosure, a method for controlling an adjustable assembly of an EOAT for a robot is provided. The method comprising: identifying a first configuration associated with a first object; configuring the adjustable assembly according to the first configuration wherein an interface of the adjustable assembly has a first position relative to a base of the adjustable assembly; engaging a tool of the adjustable assembly, thereby causing the adjustable assembly to grip the first object; disengaging the tool of the adjustable assembly; identifying a second configuration associated with a second object; configuring the adjustable assembly according to the second configuration wherein an interface of the adjustable assembly has a second position relative to a base of the adjustable assembly, the second position being different than the first position; engaging the tool of the adjustable assembly, thereby causing the adjustable assembly to grip the second object; and disengaging the tool of the adjustable assembly.

In still another exemplary embodiment of the present disclosure, an adjustable end-of-arm tool for a robot is provided. The adjustable end-of-arm tool comprising: a base adapted to be coupled to the robot; a first adjustable assembly coupled to the base, and a second adjustable assembly coupled to the base. The first adjustable assembly comprising: a first plurality of links; a first plurality of couplers coupling the plurality of links and the base, the first plurality of couplers providing at least two degrees of the freedom; and a first tool coupled to the base through the first plurality of links and the first plurality of couplers. The first tool including a first interface which is positionable relative to the base in multiple positions based on the first plurality of links and the first plurality of couplers. The second adjustable assembly comprising: a second plurality of links; a second plurality of couplers coupling the plurality of links and the base, the first plurality of couplers providing at least two degrees of the freedom; and a second tool coupled to base through the second plurality of links and the second plurality of couplers. The second tool including a second interface which is positionable relative to the base in multiple positions based on the second plurality of links and the second plurality of couplers.

In an example thereof, at least one of the first tool and the second tool is a magnetic gripper.

In another example thereof, the base has a longitudinal mid-plane. The first adjustable assembly being positioned on a first side of the longitudinal mid-plane and the second adjustable assembly being positioned on a second side of the longitudinal mid-plane, the second side being opposite the first side. In a variation thereof, the base includes a linear rail defining a first axis. In another variation thereof, the first plurality of couplers enables linear movement along the first axis, enables linear movement along a second axis perpendicular to the first axis, enables linear movement along a third axis perpendicular to both the first axis and the second axis. In a further variation thereof, the first plurality of links includes a first linear rail parallel to the second axis and slidably coupled to the linear rail; and a second linear rail parallel to the third axis and slidably coupled to the first linear rail.

In a further example thereof, the first plurality of couplers enables rotation about at least one of the first axis, the second axis, and the third axis. In a variation thereof, the first plurality of couplers enables rotation about at least two of the first axis, the second axis, and the third axis. In a further variation thereof, the first plurality of couplers enables rotation about each of the first axis, the second axis, and the third axis. In still a further variation thereof, the first plurality of couplers enables rotation about each of the first axis, the second axis, and the third axis and the first axis, the second axis, and the third axis intersect at a common point.

In still a further example thereof, the first tool and the second tool are each a single-sided tool. In a variation thereof, the single-sided tool is one of: a magnetic gripper; a suction gripper; a pin clamp; or a locator.

In yet still a further example thereof, the first tool and the second tool are each a double-sided tool. In a variation thereof, the double-sided tool is one of: a power clamp; a parallel clamp; a swing unit; a multiple finger gripping device; or a mylar gripping device.

In yet another example thereof, the adjustable end-of-arm tool further comprising: a third adjustable assembly coupled to the base. The third adjustable assembly comprising: a third plurality of links; a third plurality of couplers coupling the third plurality of links and the base, the third plurality of couplers providing at least two degrees of the freedom; and a third tool coupled to the base through the third plurality of links and the third plurality of couplers. In a variation thereof, the base has a longitudinal mid-plane. The first adjustable assembly and the third adjustable assembly being positioned on a first side of the longitudinal mid-plane and the second adjustable assembly being positioned on a second side of the longitudinal mid-plane, the second side being opposite the first side. In a further variation thereof, the first plurality of links and the first plurality of couplers provides six degrees of freedom for the positioning the first tool relative to the base, the second plurality of links and the second plurality of couplers provides six degrees of freedom for the positioning the second tool relative to the base, and the third plurality of links and the third plurality of couplers provides six degrees of freedom for the positioning the third tool relative to the base. In still a further variation thereof, each of the first adjustable assembly, the second adjustable assembly, and the third adjustable assembly are independently coupled to the base.

In yet still another example thereof, the first plurality of links and the first plurality of couplers provides six degrees of freedom for the positioning the first tool relative to the base and the second plurality of links and the second plurality of couplers provides six degrees of freedom for the positioning the second tool relative to the base. In a variation thereof, each of the first adjustable assembly and the second adjustable assembly are independently coupled to the base.

In yet a further still example thereof, the adjustable end-of-arm tool further comprises a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base. In a variation thereof, the controller is further configured to: identify a second configuration associated with a second object, wherein the second configuration is different than the first configuration; and configure the first adjustable assembly and the second adjustable assembly according to the second configuration to position the first interface of first tool in a third position relative to the base and to position the second interface of the second tool in a fourth position relative to the base.

In a further yet exemplary embodiment of the present disclosure, an adjustable fixture to receive an object is provided. The adjustable fixture comprising: a base; a first adjustable assembly coupled to the base, and a second adjustable assembly coupled to the base. The first adjustable assembly comprising: a first plurality of links; a first plurality of couplers coupling the first plurality of links and the base, the first plurality of couplers providing at least two degrees of the freedom; and a first tool coupled to the base through the first plurality of links and the first plurality of couplers. The first tool including a first interface extending above the base. The first interface being positionable relative to the base in multiple positions based on the first plurality of links and the first plurality of couplers. The second adjustable assembly comprising: a second plurality of links; a second plurality of couplers coupling the second plurality of links and the base, the second plurality of couplers providing at least two degrees of the freedom; and a second tool coupled to base through the second plurality of links and the second plurality of couplers. The second tool including a second interface extending above the base. The second interface being positionable relative to the base in multiple positions based on the second plurality of links and the second plurality of couplers.

In an example thereof, the first tool and the second tool are each a single-sided tool. In a variation thereof, the single-sided tool is one of: a magnetic gripper; a suction gripper; a pin clamp; or a locator.

In another example thereof, the first tool and the second tool are each a double-sided tool.

In a further example thereof, the adjustable fixture further comprises: a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base. In a variation thereof, the first configuration associated with the first object is identified according to a sequence comprising the first object and a second object; and the controller is further configured to: identify a second configuration associated with the second object according to the sequence; and configure the first adjustable assembly and the second adjustable assembly according to the second configuration to position the first interface of first tool in a third position relative to the base and to position the second interface of the second tool in a fourth position relative to the base.

In yet another example thereof, the first plurality of links and the first plurality of couplers provides six degrees of freedom for the positioning the first tool relative to the base and the second plurality of links and the second plurality of couplers provides six degrees of freedom for the positioning the second tool relative to the base. In a variation thereof, each of the first adjustable assembly and the second adjustable assembly are independently coupled to the base.

In still a further variation thereof, the first plurality of couplers enables rotation about each of a first axis, a second axis perpendicular to the first axis, and a third axis perpendicular to the first axis and the second axis and the first axis, the second axis, and the third axis intersect at a common point.

In yet another exemplary embodiment of the present disclosure, a method for controlling an adjustable assembly of an EOAT for a robot is provided. The method comprising: identifying a first configuration associated with a first object; configuring the adjustable assembly according to the first configuration wherein an interface of the adjustable assembly has a first position relative to a base of the adjustable assembly; engaging a tool of the adjustable assembly, thereby causing the adjustable assembly to grip the first object; disengaging the tool of the adjustable assembly; identifying a second configuration associated with a second object; configuring the adjustable assembly according to the second configuration wherein an interface of the adjustable assembly has a second position relative to a base of the adjustable assembly, the second position being different than the first position; engaging the tool of the adjustable assembly, thereby causing the adjustable assembly to grip the second object; and disengaging the tool of the adjustable assembly.

In an example thereof, the first configuration associated with the first object is identified according to a stored sequence comprising the first object and the second object; and the second configuration associated with the second object is identified according to the stored sequence.

In another example thereof, the first configuration associated with the first object is identified in response to detecting the first object using computer vision; and the second configuration associated with the second object is identified in response to detecting the second object using computer vision.

In a further example thereof, configuring the adjustable assembly according to the first configuration comprises: detecting the first object using computer vision; and dynamically configuring the adjustable assembly based on the detected first object.

In yet still another example thereof, configuring the adjustable assembly according to the first configuration comprises: identifying a location of the first object using computer vision; and configuring the interface of the adjustable assembly according to the identified location.

In still a further exemplary embodiment of the present disclosure, a method for controlling an adjustable assembly of an EOAT for a robot is provided. The adjustable assembly includes a base, a plurality of tools including a first tool having a first interface, a second tool having a second interface, and a third tool having a third interface. The first interface of the first tool being moveable relative to the base in six degrees of freedom. The second interface of the second tool being moveable relative to the base in six degrees of freedom. The third interface of the third tool being moveable relative to the base in six degrees of freedom. The method comprising: identifying a first configuration associated with a first object; configuring the adjustable assembly according to the first configuration wherein the first interface of the first tool of the adjustable assembly has a first position relative to the base, the second interface of the second tool of the adjustable assembly has a second position relative to the base, and the third interface of the third tool of the adjustable assembly has a third position relative to the base; engaging the plurality of tools of the adjustable assembly, thereby causing the adjustable assembly to grip the first object; disengaging the plurality of tool of the adjustable assembly; identifying a second configuration associated with a second object; configuring the adjustable assembly according to the second configuration wherein at least one of the first interface of the first tool, the second interface of the second tool, and the third interface of the third tool is moved relative to the first configuration; engaging the plurality of tools of the adjustable assembly, thereby causing the adjustable assembly to grip the second object; and disengaging the plurality of tools of the adjustable assembly.

In an example thereof, the first configuration associated with the first object is identified according to a stored sequence comprising the first object and the second object; and the second configuration associated with the second object is identified according to the stored sequence.

In another example thereof, the first configuration associated with the first object is identified in response to detecting the first object using computer vision; and the second configuration associated with the second object is identified in response to detecting the second object using computer vision.

In a further example thereof, configuring the adjustable assembly according to the first configuration comprises: detecting the first object using computer vision; and dynamically configuring the adjustable assembly based on the detected first object.

In still another example thereof, configuring the adjustable assembly according to the first configuration comprises: identifying a location of the first object using computer vision; and configuring the interface of the adjustable assembly according to the identified location.

In still another exemplary embodiment of the present disclosure, an adjustable end-of-arm tool for a robot is provided. The adjustable end-of-arm tool comprising: a base adapted to be coupled to the robot, a first adjustable assembly coupled to the base, and a second adjustable assembly coupled to the base. The base including a linear rail defining a first axis. The first adjustable assembly comprising: a first plurality of links; a first plurality of couplers coupling the plurality of links and the base, the first plurality of couplers enables linear movement along the first axis, enables linear movement along a second axis perpendicular to the first axis, enables linear movement along a third axis perpendicular to both the first axis and the second axis, and enables rotation about at least two of a fourth axis, a fifth axis, and a sixth axis; and a first tool coupled to the base through the first plurality of links and the first plurality of couplers. The first tool including a first interface which is positionable relative to the base in multiple positions based on the first plurality of links and the first plurality of couplers. The second adjustable assembly comprising: a second plurality of links; a second plurality of couplers coupling the plurality of links and the base, the second plurality of couplers providing at least two degrees of the freedom; and a second tool coupled to base through the second plurality of links and the second plurality of couplers. The second tool including a second interface which is positionable relative to the base in multiple positions based on the second plurality of links and the second plurality of couplers.

In an example thereof, the first plurality of couplers enables rotation about each of the fourth axis, the fifth axis, and the sixth axis. In a variation thereof, the first plurality of couplers enables rotation about each of the fourth axis, the fifth axis, and the sixth axis and the fourth axis, the fifth axis, and the sixth axis intersect at a common point.

In another example thereof, the fourth axis is the first axis, the fifth axis is the second axis, and the sixth axis is the third axis.

In still another example thereof, each of the first adjustable assembly and the second adjustable assembly are independently coupled to the base. In a variation thereof, the adjustable end-of-arm tool further comprises a third adjustable assembly coupled to the base. The third adjustable assembly comprising: a third plurality of links; a third plurality of couplers coupling the third plurality of links and the base, the third plurality of couplers providing at least two degrees of the freedom; and a third tool coupled to the base through the third plurality of links and the third plurality of couplers. In another variation thereof, the base has a longitudinal mid-plane, the first adjustable assembly and the third adjustable assembly being positioned on a first side of the longitudinal mid-plane and the second adjustable assembly being positioned on a second side of the longitudinal mid-plane, the second side being opposite the first side. In a further variation thereof, each of the first adjustable assembly, the second adjustable assembly, and the third adjustable assembly are independently coupled to the base.

In yet still another exemplary embodiment of the present disclosure, an adjustable end-of-arm tool for a robot is provided. The adjustable end-of-arm tool comprising: a base adapted to be coupled to the robot; a first adjustable assembly coupled to the base, and a second adjustable assembly coupled to the base. The first adjustable assembly comprising: a first linear adjustment subassembly coupled to the base, the first linear adjustment subassembly provides at least two degrees of linear motion relative to the base; a first rotational adjustment subassembly coupled to the base through the first linear subassembly, the first rotational adjustment subassembly provides at least two degrees of rotational motion relative to the base; and a first tool coupled to the base through the first rotational subassembly and the first linear subassembly, the first tool including a first interface which is positionable relative to the base in multiple positions based on the first linear adjustment subassembly and the first rotational adjustment subassembly. The second adjustable assembly comprising: a second linear adjustment subassembly coupled to the base; a second rotational adjustment subassembly coupled to the base through the second linear subassembly; and a second tool coupled to the base through the second rotational subassembly and the second linear subassembly, the second tool including a second interface which is positionable relative to the base in multiple positions based on the second linear adjustment subassembly and the second rotational adjustment subassembly.

In an example thereof, the first rotational adjustment subassembly provides at least three degrees of rotational motion relative to the base.

In another example thereof, the base includes a linear rail defining a first axis, the first linear adjustment subassembly includes a first plurality of links and a first plurality of couplers coupling the plurality of links and the base, the first plurality of couplers enables linear movement along the first axis, enables linear movement along a second axis perpendicular to the first axis, enables linear movement along a third axis perpendicular to both the first axis and the second axis. In a variation thereof, the first rotational adjustment subassembly provides at least three degrees of rotational motion relative to the linear adjustment subassembly about a fourth axis, a fifth axis, and a sixth axis. In another variation thereof, the fourth axis is the first axis, the fifth axis is the second axis, and the sixth axis is the third axis. In yet another variation thereof, the fourth axis, the fifth axis, and the sixth axis intersect at a common point.

In a further example thereof, the first tool and the second tool are each a single-sided tool. In a variation thereof, the single-sided tool is one of: a magnetic gripper; a suction gripper; a pin clamp; or a locator.

In yet another example thereof, the first tool and the second tool are each a double-sided tool.

In still another example thereof, the adjustable end-of-arm tool further comprising a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base. In a variation thereof, the first configuration associated with the first object is identified according to a sequence comprising the first object and a second object. The controller is further configured to: identify a second configuration associated with the second object according to the sequence; and configure the first adjustable assembly and the second adjustable assembly according to the second configuration to position the first interface of first tool in a third position relative to the base and to position the second interface of the second tool in a fourth position relative to the base.

In still yet a further example thereof, the adjustable end-of-arm tool further comprising: a third adjustable assembly coupled to the base. The third adjustable assembly comprising: a third linear adjustment subassembly coupled to the base, the third linear adjustment subassembly provides at least two degrees of linear motion relative to the base; a third rotational adjustment subassembly coupled to the base through the third linear subassembly, the third rotational adjustment subassembly provides at least two degrees of rotational motion relative to the base; and a third tool coupled to the base through the third rotational subassembly and the third linear subassembly. The third tool including a third interface which is positionable relative to the base in multiple positions based on the third linear adjustment subassembly and the third rotational adjustment subassembly. In a variation thereof, the base has a longitudinal mid-plane, the first adjustable assembly and the third adjustable assembly being positioned on a first side of the longitudinal mid-plane and the second adjustable assembly being positioned on a second side of the longitudinal mid-plane, the second side being opposite the first side. In another variation thereof, the first plurality of links and the first plurality of couplers provides six degrees of freedom for the positioning the first tool relative to the base, the second plurality of links and the second plurality of couplers provides six degrees of freedom for the positioning the second tool relative to the base, and the third plurality of links and the third plurality of couplers provides six degrees of freedom for the positioning the third tool relative to the base. In still a further variation thereof, each of the first adjustable assembly, the second adjustable assembly, and the third adjustable assembly are independently coupled to the base.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a representative front view of an adjustable assembly for use with an adjustable end-of-arm tool or adjustable fixture.

FIGS. 1B and 1C illustrate representative front and back views, respectively, of an adjustable end-of-arm tool having multiple adjustable assemblies in various configurations according to aspects of the present disclosure.

FIG. 1D illustrates a representative front view of an adjustable fixture having multiple adjustable assemblies.

FIGS. 2A-2D illustrate example views of a robotic device having an adjustable end-of-arm tool manipulating multiple objects according to aspects described herein.

FIG. 3A illustrates a front left view of an example adjustable assembly.

FIG. 3B illustrates a front right view of an example adjustable assembly.

FIG. 3C illustrates a rear left view of an example adjustable assembly.

FIG. 4A illustrates a top perspective view of an adjustable end-of-arm tool having multiple adjustable assemblies according to aspects of the present disclosure.

FIG. 4B illustrates a bottom perspective view of an adjustable end-of-arm tool having multiple adjustable assemblies according to aspects of the present disclosure.

FIG. 4C illustrates another top perspective view of an adjustable end-of-arm tool having multiple adjustable assemblies according to aspects of the present disclosure.

FIG. 5A illustrates a perspective view of a robotic device having an adjustable end-of-arm tool according to aspects of the present disclosure.

FIG. 5B illustrates a perspective view of a robotic device having another adjustable end-of-arm tool according to aspects of the present disclosure.

FIG. 6 illustrates an example of a suitable operating environment 600 in which one or more of the present embodiments may be implemented.

FIG. 7 illustrates a representative view of an exemplary adjustable end-of-arm-tool (EOAT).

FIG. 8 illustrates a representative view of an exemplary magnetic coupling device having multiple workpiece contact interfaces for each pole of the magnetic coupling device and the magnetic coupling device in an OFF state.

FIG. 9 illustrates the magnetic coupling device of FIG. 8 with the magnetic coupling device in an ON state.

FIG. 10 illustrates the magnetic coupling device of FIG. 8 with a sensing system.

FIG. 11 illustrates a representative view of an exemplary magnetic coupling device having multiple workpiece contact interfaces for each pole of the magnetic coupling device, the magnetic coupling device including a stack of permanent magnets with a first permanent magnet moveable relative to a second permanent magnet with an actuator.

FIG. 12 illustrates the magnetic coupling device of FIG. 11 including an electronic controller operatively coupled to the actuator.

FIG. 13 illustrates a representative view of an exemplary magnetic coupling device having multiple workpiece contact interfaces for each pole of the magnetic coupling device, the magnetic coupling device including a stack of permanent magnets with a first electro-permanent magnet and a second permanent magnet.

FIG. 14 illustrates a top view of an exemplary magnet and pole piece assembly of the magnetic coupling device of FIG. 11.

FIG. 15 illustrates a sectional view of another exemplary magnet and pole piece assembly of the magnetic coupling device of FIG. 11.

FIG. 16 illustrates a top view of an exemplary magnet and pole piece assembly of the magnetic coupling device of FIG. 11 without the central channel.

FIG. 17 illustrates a top view of an exemplary magnet and pole piece assembly of the magnetic coupling device of FIG. 11 without the central channel and including a ferromagnetic cores.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. The following detailed description is therefore not to be taken in a limiting sense, and the scope of the present disclosure is defined by the appended claims and their equivalents.

End-of-arm tools (EOATs) and fixtures may be used to manipulate and support objects, for example as part of a manufacturing process. As an example, an EOAT may be coupled to a robot and be used to hold an object or to move an object to a fixture, at which point the object may be supported by the fixture. Exemplary robots include industrial robots having a plurality of links moveably coupled together to alter a position of an end of the robot in space and hence the position of the EOAT. The couplers between the links of the robot may control the end of the robot in one or more translational axes and one or more rotational axes. In embodiments, the end of the robot is controllable in multiple translational axes and multiple rotational axes. However, EOATs and fixtures are typically designed for specific objects, such that a first set of EOATs and/or fixtures may be used for a first group of objects, while a second set of EOATs and/or fixtures may be used for a second group of objects. Thus, transitioning from manufacturing the first group of objects to manufacturing the second group of objects may entail changing out the first set of EOATs and fixtures with the second set of EOATs and fixtures.

This may introduce additional time to the manufacturing process, as well as added complexity and additional space requirements (e.g., to store multiple sets of EOATs and fixtures). Additionally, such specialized EOATS and fixtures may grip objects from multiple edges and/or sides, such that the size of the EOATs and fixtures may be comparable to or exceed that of the objects for which they are used. More powerful robotic devices may be required to effectively control such large EOATs, resulting in additional energy consumption, added mechanical complexity, and increased space requirements, among other detriments.

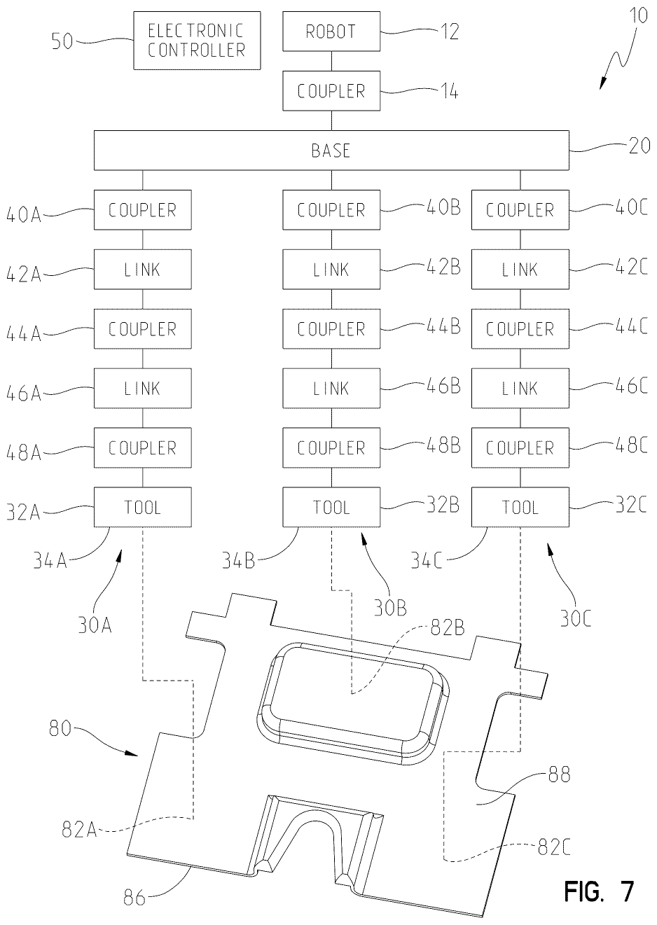

Accordingly, aspects of the present disclosure relate to an adjustable EOAT or fixture. As an example, a set of adjustable assemblies may be used as an EOAT or a fixture, where each adjustable assembly may be used to control a tool. Referring to FIG. 7, an exemplary adjustable EOAT 1010 is illustrated. EOAT 1010 is coupled to an end of a robot 1012 through one or more couplers 1014. In embodiments, couplers 1014 fix EOAT 1010 relative to robot 1012. In embodiments, one or more couplers 1014 permit one or more degrees of movement (translational and/or rotational) of EOAT 1010 relative to robot 1012. Exemplary couplers include linear translation mounts, rotational mounts, and other suitable mounts.

EOAT 1010 includes a base 1020 which as illustrated is coupled to robot 1012 through coupler 1014. Base 1020 may include one or more components coupled through in an assembly. Base 1020 carries a plurality of adjustable assemblies 1030A-C. Although three adjustable assemblies 1030A-C are shown, fewer or additional adjustable assemblies may be included as part of EOAT 1010.

Each adjustable assembly 1030 includes a tool 1032 which interfaces with one or more workpieces 1080 to be moved by EOAT 1010 and robot 1012. Exemplary tools include grippers, pin clamps, clamps, and locators. As shown in FIG. 7, tools 1032A-C interfaces with workpiece 1080, illustratively a stamped metal component, at locations 1082A-C. Each of locations 1082A-C are inbound of a perimeter envelope 1086 of workpiece 1080. Thus, a footprint of EOAT 1010 defined by interfaces 1034A-C of tools 1032A-C is completely within perimeter envelope 1086 of workpiece 1080. Although in the illustrated embodiment, each of interfaces 1034A-C of tools 1032A-C are within perimeter envelope 1086 of workpiece 1080, in embodiments, one or more of tools may extend over an outside portion of perimeter envelope 1086 and the respective interface of the tool interact with both a front side 1088 of workpiece 1080 and a rear side (not shown) of workpiece 1080. As mentioned herein the positions of interfaces 1034A-C of tools 1032A-C may be positioned in multiple positions relative to base 1020. It should be noted that the positions of interfaces 1034A-C relative to base 1020 need not be determined rather the positioned relative to base 1020 simply provides a reference. In actuality, the interfaces may be positioned based on a coordinate system of the robot, the adjustable assembly itself, or other coordinate systems in the system.

Exemplary locators include pins and other locating features. Exemplary grippers include suction cup grippers and magnetic grippers. Magnetic grippers are also referred to herein as magnetic coupling devices. Suction cup grippers include cups as the respective interface 1034 with workpiece 1080 and a pneumatic system which selectively applies a vacuum to the cup grippers to hold workpiece 1080 relative to EOAT 1010. Magnetic grippers are used with ferromagnetic workpieces 1080 and generally include pole shoes as the respective interface 1034 with workpiece 1080 and a magnetic flux source which supplies a magnetic flux at the surface of the pole shoes to create a magnetic circuit through the pole shoes and workpiece. 1080. Exemplary magnetic flux sources include electromagnets, electro-permanent magnets, rare earth permanent magnets, other suitable magnets, and combinations thereof. Exemplary magnetic grippers are disclosed in U.S. Pat. Nos. 7,012,495, 8,878,639, 10,903,030; US Published Patent Application Nos. US20180311795 and US20210031317; U.S. Provisional Patent Application No. 63/194,692; and Published PCT Application No. WO2020086791A1, the entire disclosures of which are expressly incorporated by reference herein.

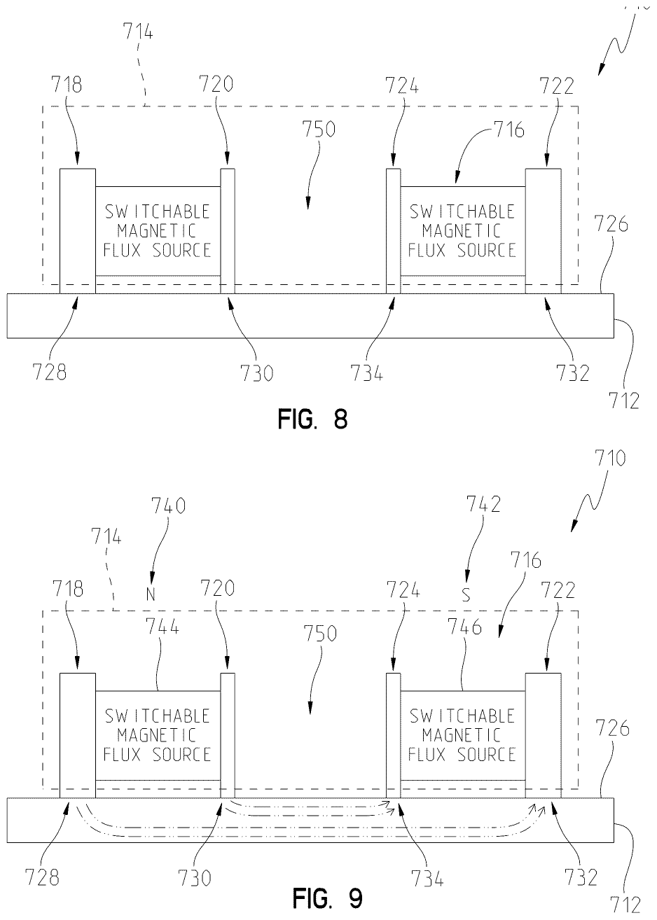

Referring to FIG. 8, an exemplary magnetic coupling device 1710 is shown. Magnetic coupling device 1710 is configured to magnetically couple a ferromagnetic workpiece 1712. Magnetic coupling device 1710 includes a housing 1714, a switchable magnetic flux source 1716, a first north pole portion 1718, a second north pole portion 1720, a first south pole portion 1722, and a second south pole portion 1724. First north pole portion 1718 includes a workpiece interface 1728, second north pole portion 1720 includes a workpiece interface 1730, first south pole portion 1722 includes a workpiece interface 1732, and second south pole portion 1724 includes a workpiece interface 1734, each of which contacts a respective part of ferromagnetic workpiece 1712, illustratively a surface 1726 of ferromagnetic workpiece 1712. Each of workpiece interface 1728, workpiece interface 1730, workpiece interface 1732, and workpiece interface 1734 include at least one workpiece engagement surface. Workpiece interface 1728, workpiece interface 1730, workpiece interface 1732, and workpiece interface 1734 may each be planar, curved, contoured, have a plurality of spaced apart projections, or any other suitable shape for contacting ferromagnetic workpiece 1712. Each of first north pole portion 1718, second north pole portion 1720, first south pole portion 1722, and second south pole portion 1724 are made of a ferromagnetic material and may be a part of housing 1714 or separate components coupled to housing 1714.

Switchable magnetic flux source 1716 of magnetic coupling device 1710 is switchable between an OFF state wherein a magnetic circuit is formed within housing 1714 and an ON state wherein a magnetic circuit is formed from switchable magnetic flux source 1716 through workpiece interface 1728 and workpiece interface 1730 of magnetic coupling device 1710, through ferromagnetic workpiece 1712, through workpiece interface 1732 and workpiece interface 1734 of magnetic coupling device 1710, and back to switchable magnetic flux source 1716 (as represented by the arrows shown in FIG. 9). In embodiments, switchable magnetic flux source 1716 may be placed in at least one partial ON state wherein the strength of the magnetic circuit formed through ferromagnetic workpiece 1712 is more than the OFF state and less than the ON state.

Switchable magnetic flux source 1716 may include multiple permanent magnets and is configurable to have an overall north pole portion 1744 and an overall south pole portion 1746. As shown in FIG. 9, overall north pole portion 1744 of switchable magnetic flux source 1716 is positioned between first north pole portion 1718 and second north pole portion 1720 and overall south pole portion 1746 of switchable magnetic flux source 1716 is positioned between first south pole portion 1722 and second south pole portion 1724. Overall north pole portion 1744 of switchable magnetic flux source 1716 is magnetically coupled with first north pole portion 1718 and second north pole portion 1720 resulting in workpiece interface 1728 of first north pole portion 1718 and workpiece interface 1730 of second north pole portion 1720 forming an overall north pole 1740 of magnetic coupling device 1710. Overall south pole portion 1746 is magnetically coupled with first south pole portion 1722 and second south pole portion 1724 resulting in workpiece interface 1732 of first south pole portion 1722 and workpiece interface 1734 of second south pole portion 1724 forming an overall south pole 1742 of magnetic coupling device 1710.

Switchable magnetic flux source 1716 may include one or more permanent magnets and is configurable to have an overall north pole portion 1744 and an overall south pole portion 1746. In embodiments, switchable magnetic flux source 1716 includes at least one electro-permanent magnet which is switchable between an ON state (having a north pole and a south pole) and an OFF state (not magnetized relative to external objects). Further, the at least one electro-permanent magnet may be configured to have varying magnetic strengths which allow the device to be configured in a partial ON state having a magnetic strength at workpiece interfaces 1728, 1730, 1732, and 1734 less than the ON state and greater than an OFF state. In embodiments, switchable magnetic flux source 1716 includes at least one rare earth permanent magnet and at least one electro-permanent magnet, the combination of which is switchable between an ON state having a magnetic strength at workpiece interfaces 1728, 1730, 1732, and 1734 and an OFF state wherein a magnetic circuit is formed internally to housing 1714. Further, the combination may be configured to have varying magnetic strengths which allow the device to be configured in a partial ON state having a magnetic strength at workpiece interfaces 1728, 1730, 1732, and 1734 less than the ON state and greater than an OFF state. In embodiments, switchable magnetic flux source 1716 includes a plurality of rare earth permanent magnets, the combination of which is switchable between an ON state having a magnetic strength at workpiece interfaces 1728, 1730, 1732, and 1734 and an OFF state wherein a magnetic circuit is formed internally to housing 1714. Further, the combination may be configured to have varying magnetic strengths which allow the device to be configured in a partial ON state having a magnetic strength at workpiece interfaces 1728, 1730, 1732, and 1734 less than the ON state and greater than an OFF state. In embodiments, switchable magnetic flux source 1716 includes at least one rare earth permanent magnet which is moveable relative to the housing 1714 to thus be switchable between an ON state having a magnetic strength at workpiece interfaces 1728, 1730, 1732, and 1734 and an OFF state wherein a magnetic circuit is formed internally to housing 1714.

As shown in FIGS. 8 and 9, a channel 1750 is provided between pole portions 1720 and 1724. Channel 1750, as discussed herein, may receive one or more sensors, stationary pins, retractable pins, probes, and/or additional tools.

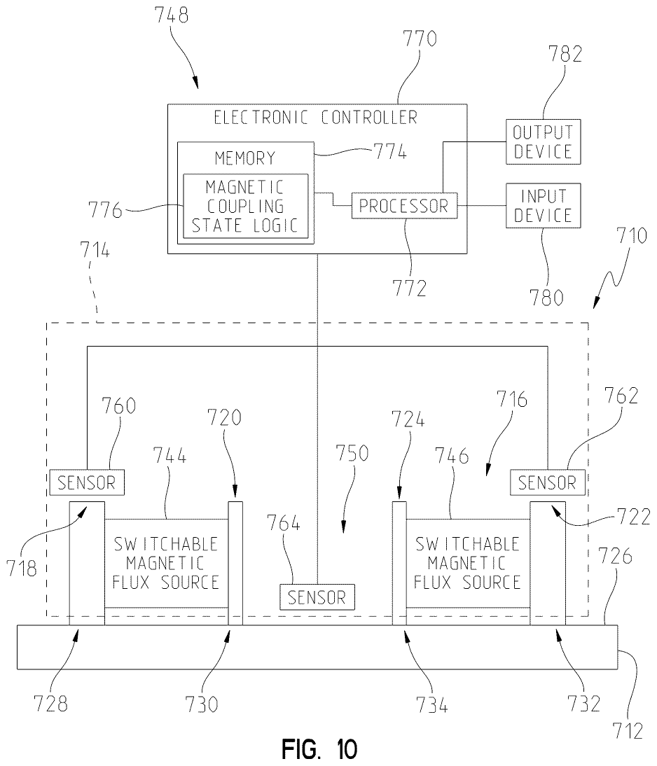

Referring to FIG. 10, in embodiments, magnetic coupling device 1710 further includes a monitoring system 1748 including one or more sensors which monitor a characteristic of magnetic coupling device 1710 and/or a characteristic of a magnetic circuit formed between magnetic coupling device 1710 and ferromagnetic workpiece 1712. As shown in FIG. 10, a first sensor 1760 may be positioned proximate first north pole portion 1718, a second sensor 1762 may be positioned proximate first south pole portion 1722, and a third sensor 1764 may be positioned proximate ferromagnetic workpiece 1712 in a channel 1750 provided between second north pole portion 1720 and second south pole portion 1724. Each of first sensor 1760, second sensor 1762, and third sensor 1764 may be a magnetic flux sensor. Additional types of sensors include temperature sensors which are used to compensate for temperature dependent drift in the magnetic flux sensors. Additionally, the positions of sensors 1760, 1762, and 1764 are exemplary and one or sensors may be positioned at different locations. In embodiments, sensor 1764 may be a proximity sensor. Exemplary proximity sensors include inductive sensors, ultrasound sensors, photonic sensors, and other suitable sensors.

Each of sensors 1760, 1762, and 1764 are operatively coupled to an electronic controller 1770. Electronic controller 1770 includes at least one processor 1772 and associated memory 1774. Memory 1774 includes magnetic coupling state logic 1776, logic control circuit, which monitors the output of sensors 1760, 1762, 1764 to determine one or more characteristics of magnetic coupling device 1710 and/or one or more characteristics of a magnetic circuit formed between magnetic coupling device 1710 and ferromagnetic workpiece 1712. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. This disclosure contemplates other embodiments in which electronic controller 1770 is not microprocessor-based, but rather is configured to control operation of magnetic coupling device 1800 based on one or more sets of hardwired instructions. Further, electronic controller 1770 may be contained within a single device or be a plurality of devices networked together or otherwise electrically connected to provide the functionality described herein.

Electronic controller 1770 may further receive input through one or more input devices 1780. Exemplary input devices include buttons, switches, levers, dials, touch displays, soft keys, and a communication module. Electronic controller 1770 may further provide output through one or more output devices 1782. Exemplary output devices include visual indicators, audio indicators, and a communication module. Exemplary visual indicators include displays, lights, and other visual systems. Exemplary audio indicators include speakers and other suitable audio systems.

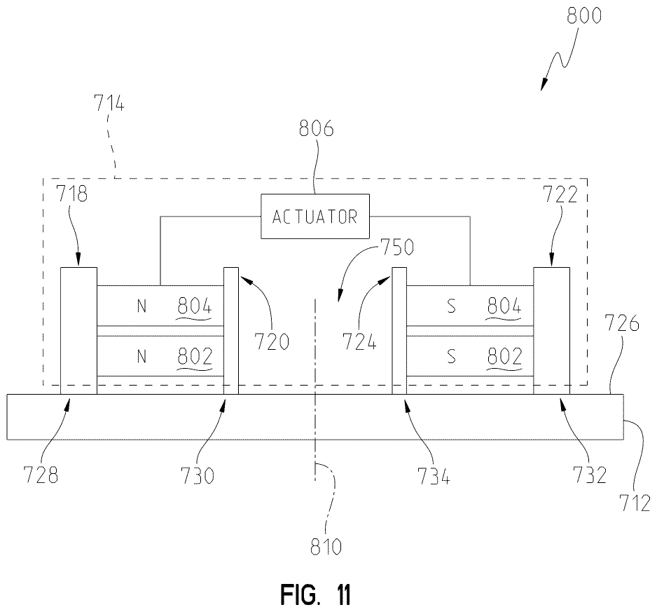

Referring to FIG. 11, each of workpiece interface 1730 and workpiece interface 1734 are closer to rotational axis 1810 than either of first permanent magnet 1802 and second permanent magnet 1804. Between workpiece interface 1730 and workpiece interface 1734 is channel 1750 which as mentioned herein may receive one or more sensors, stationary pins, retractable pins, retractable pin clamps, cameras, probes, and/or additional tools. Workpiece interface 1730 of second north pole portion 1720 and workpiece interface 1734 of second south pole portion 1724 provide an external north pole of magnetic coupling device 1800 and an external south pole of magnetic coupling device 1800, respectively, of a magnetic circuit formed with rare earth permanent magnets without any of the rare earth permanent magnets forming the magnetic circuit being positioned between second north pole portion 1720 and second south pole portion 1724. Further, in embodiments, each of first permanent magnet 1802 and second permanent magnet 1804 surround rotational axis 1810 and each of first permanent magnet 1802 and second permanent magnet 1804 include a respective aperture to form part of channel 1750.

Referring to FIG. 11, an exemplary embodiment of magnetic coupling device 1710 is shown, illustratively magnetic coupling device 1800. Magnetic coupling device 1800 includes a switchable magnetic flux source 1716 having a first permanent magnet 1802 and a second permanent magnet 1804. Second permanent magnet 1804 is spaced apart from first permanent magnet 1802. In embodiments, a spacer (not shown) is positioned between first permanent magnet 1802 and second permanent magnet 1804. In embodiments, each of first permanent magnet 1802 and second permanent magnet 1804 are rare earth permanent magnets.

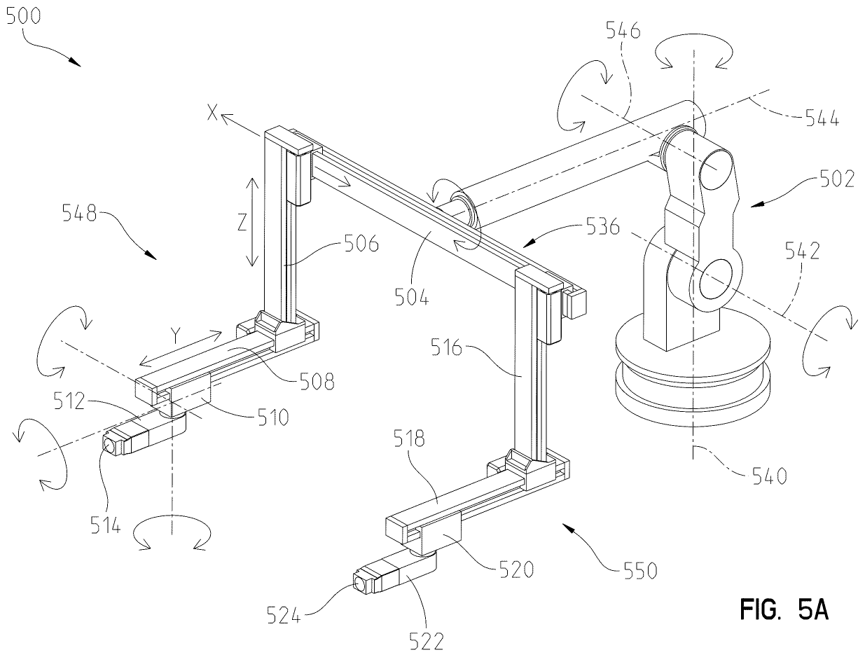

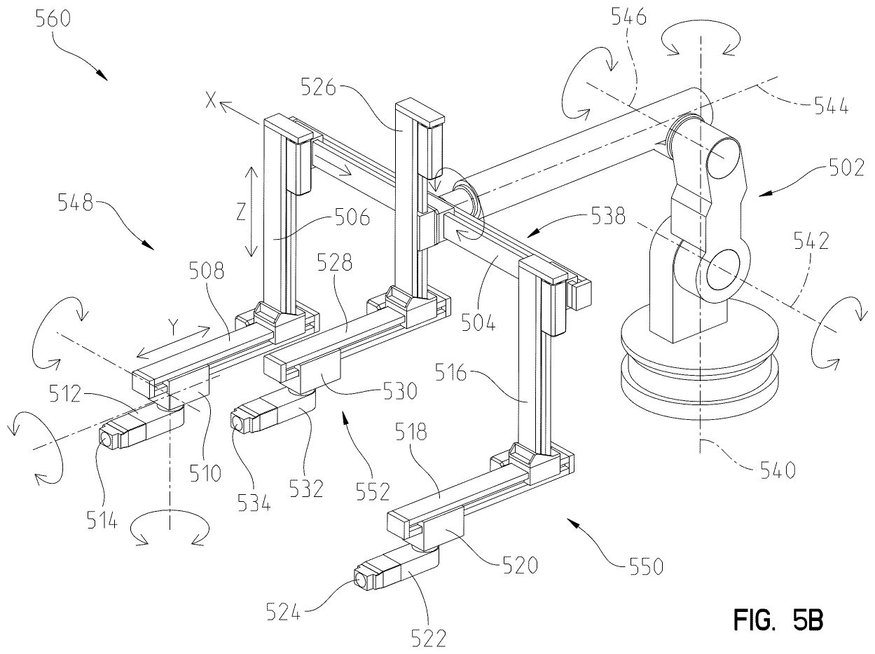

Second permanent magnet 1804 is moveable relative to first permanent magnet 1802. magnetic coupling device 1800 includes an actuator 1806 which positions second permanent magnet 1804 relative to first permanent magnet 1802. Exemplary actuators 1806 include manual actuators, hydraulic actuators, pneumatic actuators, mechanical actuators, electrically controlled actuators, and combinations thereof. Referring to FIG. 5, actuator 1806 is an electrically controlled actuator and includes a motor (not shown) which is controlled by electronic controller 1770 to position second permanent magnet 1804 relative to first permanent magnet 1802. Exemplary actuators are disclosed in U.S. Pat. No. 10,903,030, the entire disclosure of which is expressly incorporated by reference herein.

In embodiments, actuator 1806 rotates second permanent magnet 1804 relative to first permanent magnet 1802 about a rotational axis 1810. First permanent magnet 1802 is held fixed relative to housing 1714. Workpiece interface 1728 of first north pole portion 1718, workpiece interface 1730 of second north pole portion 1720, workpiece interface 1732 of first south pole portion 1722, and workpiece interface 1734 of second south pole portion 1724 are magnetically coupled to first permanent magnet 1802 and second permanent magnet 1804. In embodiments, one or both of first permanent magnet 1802 and second permanent magnet 1804 are comprised of a single rare earth magnet. In embodiments, one or both of first permanent magnet 1802 and second permanent magnet 1804 are comprised of a multiple rare earth magnets that collectively form the respective first permanent magnet 1802 or second permanent magnet 1804.

In one position of second permanent magnet 1804 relative to first permanent magnet 1802, a north pole of second permanent magnet 1804 is generally aligned with a north pole of first permanent magnet 1802 and a south pole of second permanent magnet 1804 is generally aligned with a south pole of first permanent magnet 1802, as shown in FIG. 11. This configuration corresponds to magnetic coupling device 1800 being in an ON state with workpiece interface 1728 of first north pole portion 1718 and workpiece interface 1730 of second north pole portion 1720 corresponding to an external north pole of magnetic coupling device 1800 and workpiece interface 1732 of first south pole portion 1722 and workpiece interface 1734 of second south pole portion 1724 corresponding to an external south pole of magnetic coupling device 1800. In the ON state, when magnetic coupling device 1800 is in contact with ferromagnetic workpiece 1712, a magnetic circuit is formed to magnetically couple ferromagnetic workpiece 1712 to magnetic coupling device 1800.

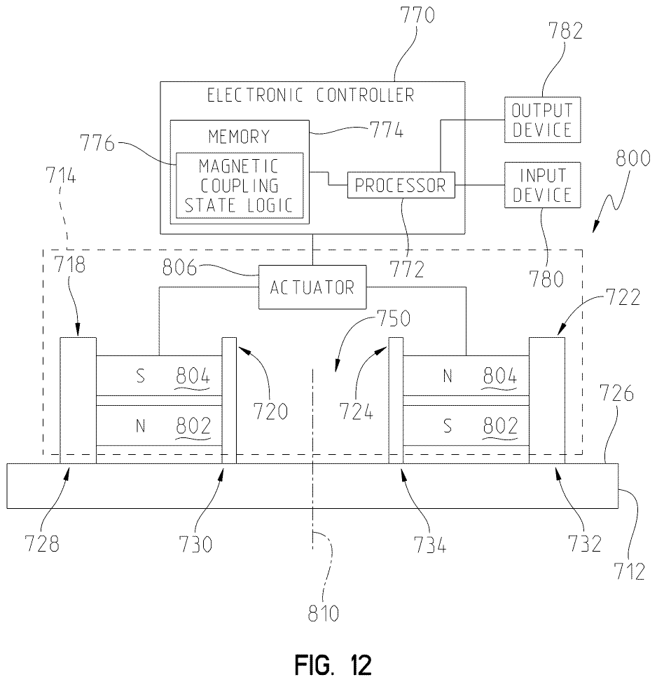

In another position of second permanent magnet 1804 relative to first permanent magnet 1802, a north pole of second permanent magnet 1804 is generally aligned with a south pole of first permanent magnet 1802 and a south pole of second permanent magnet 1804 is generally aligned with a north pole of first permanent magnet 1802, as shown in FIG. 12. This configuration corresponds to magnetic coupling device 1800 being in an OFF state and a magnetic circuit is formed generally within housing 1714; magnetic coupling device 1800 lacks an external north pole at workpiece interface 1728 of first north pole portion 1718 and workpiece interface 1730 of second north pole portion 1720 and an external south pole at workpiece interface 1732 of first south pole portion 1722 and workpiece interface 1734 of second south pole portion 1724. In the OFF state, ferromagnetic workpiece 1712 is not magnetically coupled to magnetic coupling device 1800.

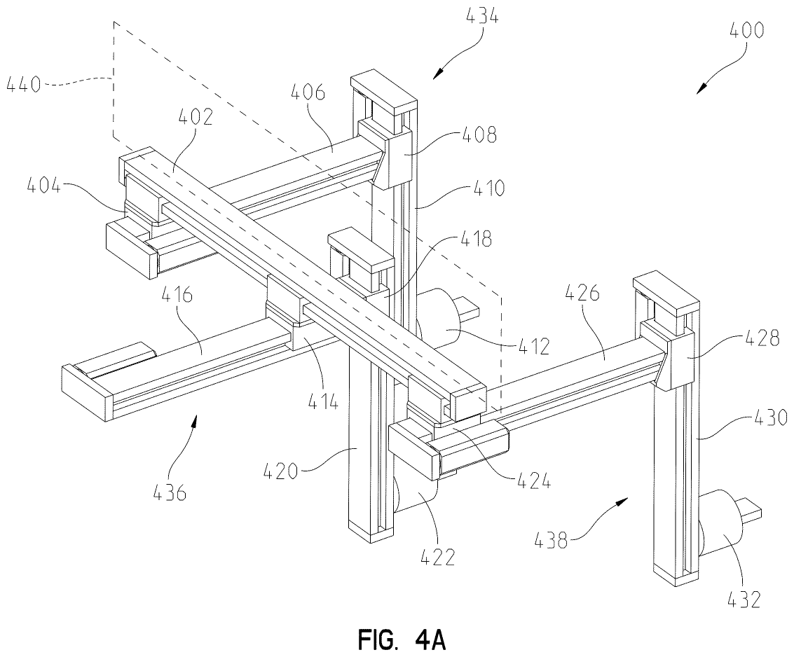

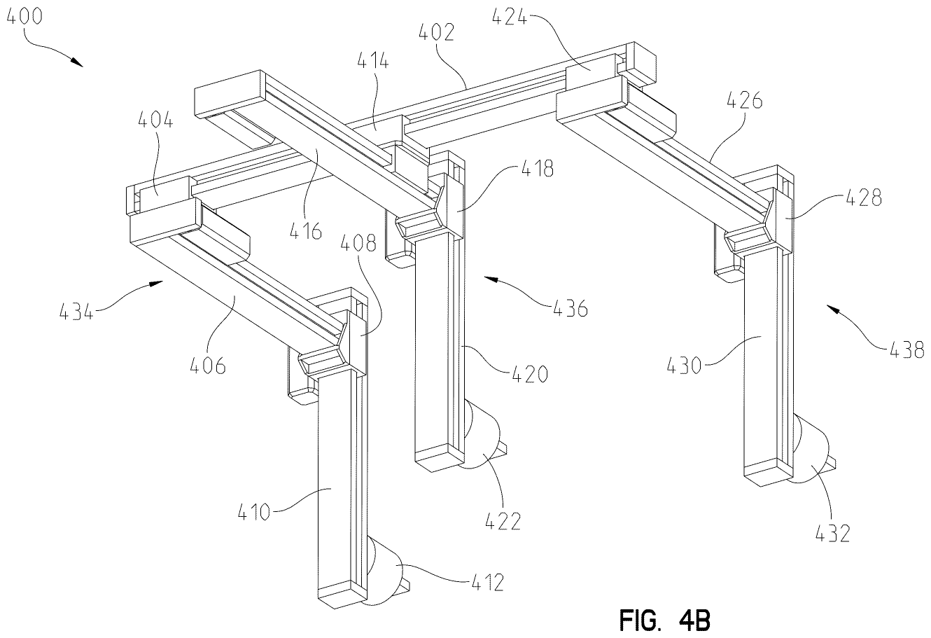

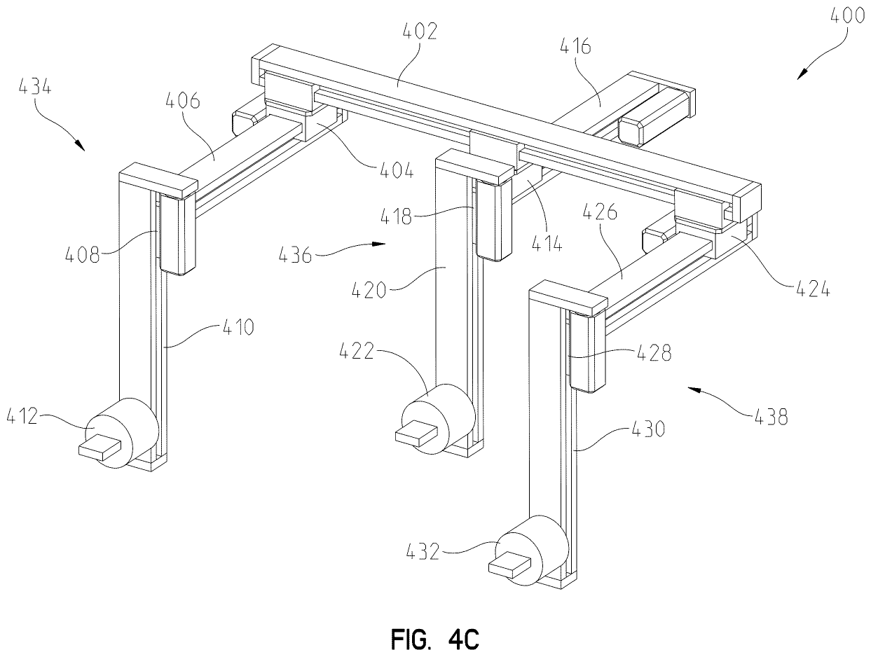

Actuator 1806 rotates second permanent magnet 1804 about rotational axis 1810 to move second permanent magnet 1804 between the positions shown in FIG. 4 and FIG. 12. In embodiments, actuator 1806 is able to position second permanent magnet 1804 at rotational positions between those shown in FIGS. 11 and 12. These intermediate rotational positions correspond to partial ON states of magnetic coupling device 1800 with workpiece interface 1728 of first north pole portion 1718 and workpiece interface 1730 of second north pole portion 1720 corresponding to an external north pole of magnetic coupling device 1800 and workpiece interface 1732 of first south pole portion 1722 and workpiece interface 1734 of second south pole portion 1724 corresponding to an external south pole of magnetic coupling device 1800, but having a lower level of magnetic flux available at each of the external north pole and the external south pole. As such, magnetic coupling device 1800 is able to be configured to provide a variable strength magnetic flux level to perform various operations, such as the operations disclosed in U.S. Pat. No. 10,903,030, the entire disclosure of which is expressly incorporated by reference herein.

Referring to FIG. 11, each of workpiece interface 1730 and workpiece interface 1734 are closer to rotational axis 1810 than either of first permanent magnet 1802 and second permanent magnet 1804. Between workpiece interface 1730 and workpiece interface 1734 is channel 1750 which as mentioned herein may receive one or more sensors and/or tools, such as probes. Workpiece interface 1730 of second north pole portion 1720 and workpiece interface 1734 of second south pole portion 1724 provide an external north pole of magnetic coupling device 1800 and an external south pole of magnetic coupling device 1800, respectively, of a magnetic circuit formed with rare earth permanent magnets without any of the rare earth permanent magnets forming the magnetic circuit being positioned between second north pole portion 1720 and second south pole portion 1724. Further, in embodiments, each of first permanent magnet 1802 and second permanent magnet 1804 surround rotational axis 1810 and each of first permanent magnet 1802 and second permanent magnet 1804 include a respective aperture to form part of channel 1750.

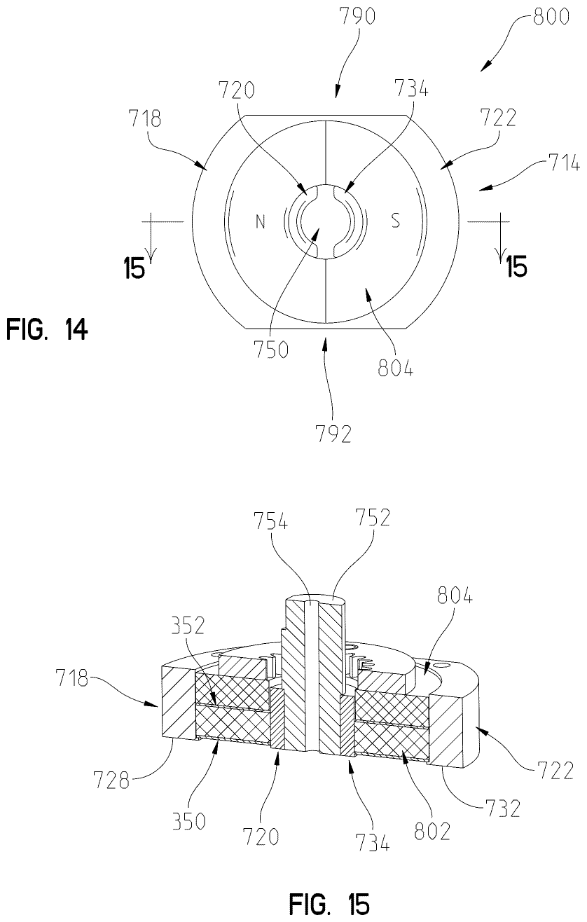

Referring to FIGS. 14 and 15, an exemplary arrangement for magnetic coupling device 1800 is shown. Second north pole portion 1720 and workpiece interface 1734 are carried by a support 1752 (see FIG. 15). Channel 1750 is provided as a central opening 1754 through support 1752.

Referring to FIG. 14, housing 1714 is made of a ferromagnetic material. An exemplary ferromagnetic material is steel. Housing 1714 is dimensioned such that only thin wall webs 1790 and 1792 connect first north pole portion 1718 and housing 1714 which are both thick walled portions of housing 1714. By having thin wall webs 1790 and thin wall webs 1792 being thinner than first north pole portion 1718 and first south pole portion 1722, the magnetic flux is directed through workpiece interface 1728 of first north pole portion 1718 and workpiece interface 1732 of first south pole portion 1722 into ferromagnetic workpiece 1712 instead of passing between first north pole portion 1718 and first south pole portion 1722 through thin wall webs 1790 and thin wall webs 1792.

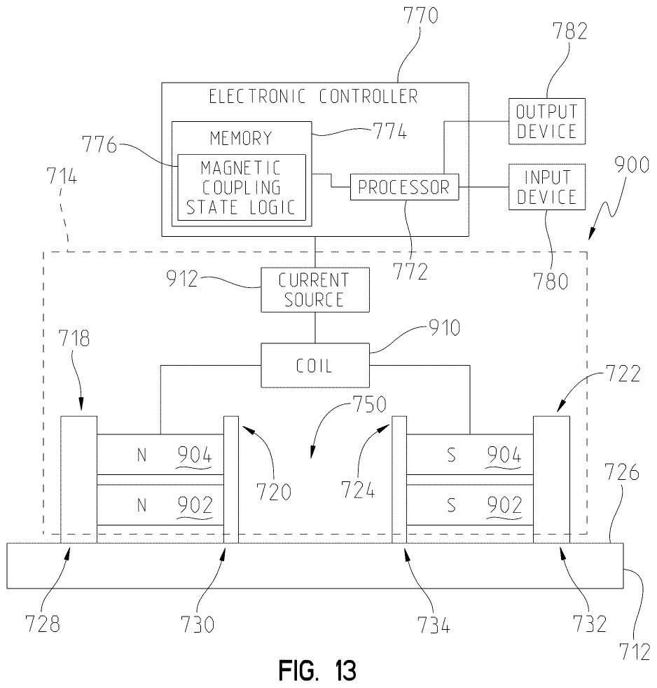

Referring to FIG. 13, an exemplary embodiment of magnetic coupling device 1710 is shown, illustratively magnetic coupling device 1900. Magnetic coupling device 1900 includes a switchable magnetic flux source 1716 having a first permanent magnet 1902 and a second permanent magnet 1904. Second permanent magnet 1904 is spaced apart from first permanent magnet 1902. In embodiments, a spacer (not shown) is positioned between first permanent magnet 1902 and second permanent magnet 1904 or an air gap is maintained between first permanent magnet 1902 and second permanent magnet 1904. In embodiments, first permanent magnet 1902 is a rare earth permanent magnet and second permanent magnet 1904 is an electro-permanent magnet. First permanent magnet 1902 and second permanent magnet 1904 are held fixed relative to housing 1714. Workpiece interface 1728 of first north pole portion 1718, workpiece interface 1730 of second north pole portion 1720, workpiece interface 1732 of first south pole portion 1722, and workpiece interface 1734 of second south pole portion 1724 are magnetically coupled to first permanent magnet 1902 and second permanent magnet 1904.

At least a portion of second permanent magnet 1904 is surrounded by a coil 1910 which is coupled to a current source 1912. A direction and strength of a current provided through coil 1910 is controlled by electronic controller 1770. The current is used to alter the pole positions for second permanent magnet 1904. In embodiments, the current may be used to position a north pole of second permanent magnet 1904 in general alignment with a north pole of first permanent magnet 1902 and a south pole of second permanent magnet 1904 is general alignment with a south pole of first permanent magnet 1902, as shown in FIG. 13. The current does not need to be persistent to maintain second permanent magnet 1904 in this configuration. This configuration corresponds to magnetic coupling device 1900 being in an ON state with workpiece interface 1728 of first north pole portion 1718 and workpiece interface 1730 of second north pole portion 1720 corresponding to an external north pole of magnetic coupling device 1900 and workpiece interface 1732 of first south pole portion 1722 and workpiece interface 1734 of second south pole portion 1724 corresponding to an external south pole of magnetic coupling device 1900. In the ON state, when magnetic coupling device 1900 is in contact with ferromagnetic workpiece 1712, a magnetic circuit is formed to magnetically couple ferromagnetic workpiece 1712 to magnetic coupling device 1900. In embodiments, the magnetic mass of first permanent magnet 1902 and second permanent magnet 1904 may be different or the same. In embodiments, one or both of first permanent magnet 1902 and second permanent magnet 1904 are comprised of a permanent magnet. In embodiments, one or both of first permanent magnet 1802 and second permanent magnet 1804 are comprised of multiple permanent magnets that collectively form the respective first permanent magnet 1802 or second permanent magnet 1804.

In embodiments, the current may be used to position a north pole of second permanent magnet 1904 in general alignment with a south pole of first permanent magnet 1902 and a south pole of second permanent magnet 1904 in general alignment with a north pole of first permanent magnet 1902. This configuration corresponds to magnetic coupling device 1900 being in an OFF state and a magnetic circuit is formed generally within housing 1714; magnetic coupling device 1900 lacks an external north pole at workpiece interface 1728 of first north pole portion 1718 and workpiece interface 1730 of second north pole portion 1720 and an external south pole at workpiece interface 1732 of first south pole portion 1722 and workpiece interface 1734 of second south pole portion 1724. In the OFF state, ferromagnetic workpiece 1712 is not magnetically coupled to magnetic coupling device 1800.

In embodiments, the electro permanent magnet of the second permanent magnet 1904 may be charged to different levels to provide a variable magnetic strength at the workpiece interfaces 1728, 1730, 1732, 1734. Thus, at least one partial ON state may be configured having a magnetic strength at the workpiece interfaces 1728, 1730, 1732, 1734 being less than the ON state and greater than the OFF state. Exemplary electro-permanent magnets include AlNiCo electro-permanent magnets.

Referring to FIG. 13, between workpiece interface 1730 and workpiece interface 1734 is channel 1750 which as mentioned herein may receive one or more sensors and/or tools, such as probes. In embodiments, each of first permanent magnet 1802 and second permanent magnet 1804 surround rotational axis 1810 and each of first permanent magnet 1802 and second permanent magnet 1804 include a respective aperture to form part of channel 1750.

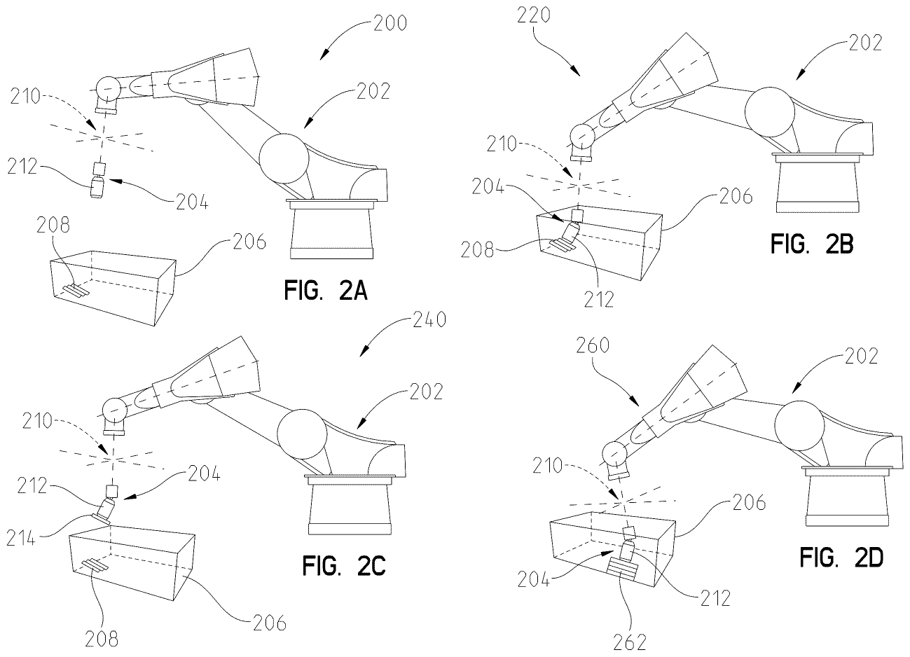

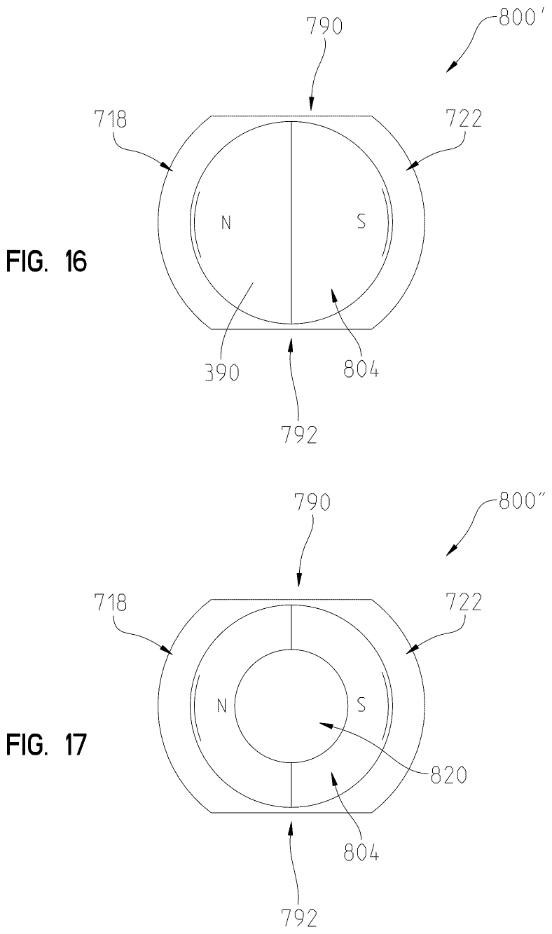

Referring to FIG. 16, in embodiments, magnetic coupling device 1800′ does not include channel 1750. Rather, each of first permanent magnet 1802 and second permanent magnet 1804 are solid circular permanent magnets. In embodiments, a plurality of magnets may collectively form one or both of first permanent magnet 1802 and second permanent magnet 1804. Further, each of first permanent magnet 1802 and second permanent magnet 1804 may have various shapes. An exemplary arrangement is shown in FIGS. 2, 4, and 7 of U.S. Pat. No. 10,903,030, issued Jan. 26, 2021, titled VARIABLE FIELD MAGNETIC COUPLERS AND METHODS FOR ENGAGING A FERROMAGNETIC WORKPIECE, the entire disclosure of which are expressly incorporated by reference herein. Another exemplary arrangement is shown in U.S. Pat. No. 7,012,495, titled SWITCHABLE PERMANENT MAGNETIC DEVICE, the entire disclosure of which are expressly incorporated by reference herein. Further, each of first permanent magnet 1802 and second permanent magnet 1804 may be a platter containing multiple magnets. An exemplary arrangement is shown in FIGS. 17-19 of U.S. Pat. No. 10,903,030, issued Jan. 26, 2021, titled VARIABLE FIELD MAGNETIC COUPLERS AND METHODS FOR ENGAGING A FERROMAGNETIC WORKPIECE, the entire disclosure of which are expressly incorporated by reference herein.

Referring to FIG. 17, in embodiments, magnetic coupling device 1800″ does not include channel 1750, but each of first permanent magnet 1802 and second permanent magnet 1804 includes a ferromagnetic core (ferromagnetic core 1820 for second permanent magnet 1804 shown in FIG. 17). An exemplary arrangement is shown in U.S. Provisional Patent Application No. 63/351,349, filed Jun. 11, 2022, titled MAGNETIC COUPLING DEVICE, docket MTI-0034-01-US, the entire disclosure of which are expressly incorporated by reference herein.

Returning to FIG. 7, each adjustable assembly 1030A-C illustratively includes a plurality of links and a plurality of couplers. In the illustrated embodiment, a first coupler 1040A-C couples a first link 1042A-C to base 1020, a second coupler 1044A-C couples first link 1042A-C to a second link 1046A-C, and a third coupler 1048A-C couples second link 1046A-C to tool 1032A-C. In embodiments, one or more of couplers 1040A-C, 4104A-C, and 1048A-C fix the respective components being coupled together. In embodiments, one or more couplers 1040A-C, 1044A-C, and 1048A-C permit one or more degrees of movement (translational and/or rotational) between the respective components being coupled together. Exemplary couplers include linear translation mounts, rotational mounts, and other suitable mounts. A given coupler 1040A-C, 1044A-C, and 1048A-C may contain multiple stages of mounts to provide more than one degree of freedom between the respective components being coupled together and/or a mount that itself provides multiple degrees of freedom. In embodiments, a given one of couplers 1040A-C, 1044A-C, and 1048A-C may provide a single degree of freedom between the respective components being coupled together. In embodiments, a given one of couplers 1040A-C, 1044A-C, and 1048A-C may provide multiple degrees of freedom between the respective components being coupled together. In embodiments, a given one of couplers 1040A-C, 1044A-C, and 1048A-C may provide both at least one rotational degree of freedom and at least one translational degree of freedom.

In embodiments, the positioning of the respective components coupled together by couplers 1040A-C, 1044A-C, and 1048A-C are controlled by an electronic controller 1050. Electronic controller 1050 controls one or more actuators of the respective couplers 1040A-C, 1044A-C, and 1048A-C to move the corresponding coupled components relative to each other and/or to hold the position of the corresponding coupled components relative to each other. Although illustrated as a single electronic controller 1050, electronic controller 1050 may be one or more controllers which control the operation of couplers 1040A-C, 1044A-C, and 1048A-C. Further, electronic controller 1050 may control the operation of coupler 1014 and/or robot 1012.

As explained herein, by adjusting the relative positions of interfaces 1034 of tools 1032, EOAT may be easily used with multiple workpieces having different shapes and/or same shaped workpieces randomly placed in a container. Further, the description of EOAT 1010 may also be implemented as a fixture to hold workpiece 1080. In the case of a fixture, base 1020 supports adjustable assemblies 1030A-C relative to the floor or other support.

As described herein, an adjustable assembly may comprise a linear adjustment subassembly and a rotational adjustment subassembly, such that the tool of the adjustable assembly is linearly controllable along the x, y, and z axes (e.g., by the linear adjustment subassembly), as well as rotationally controllable about the x, y, and z axes (e.g., by the rotational adjustment subassembly). While example movements are described herein, it will be appreciated that any of a variety of additional or alternative movements may be implemented by an adjustable assembly according to aspects described herein. Further, the grouping of translational movements (linear movements) in one sub-assembly and rotational movements (angular movements) in another sub-assembly is for the ease of the reader, not due to a requirement that they be in separate sub-assemblies. On the contrary, it is possible, in embodiments to have a given sub-assembly that provides both translational and rotational motion.

In embodiments, one or more of the adjustable assemblies may have less than six degrees of freedom. In embodiments, one or more of the adjustable assemblies may have more than six degrees of freedom. In embodiments, each of the adjustable assemblies includes the same number of degrees of freedom. In embodiments, at least two of the adjustable assemblies have different numbers of degrees of freedom.

Example tools include, but are not limited to, a gripper (e.g., a magnetic gripper, a suction gripper, or a pin clamp) or a locator (e.g., a 2-way locating pin or a 4-way locating pin). In examples, a tool may engage with an object from substantially one side. For example, a magnetic gripper or a suction gripper may be referred to herein as single-sided tools that act on an object from the side at which the magnetic or suction force is provided. Similarly, a pin clamp or locator may engage with an object through a hole of the object. A pin clamp may include a retractable pin that is extended on the opposite side of the object. In such an example, a separate tool may not be required to exert force that is opposite that of the pin clamp, such that a pin clamp may also be a single-sided tool. Thus, such aspects may be in contrast to gripping an object from opposing edges or on both sides of the object using multiple tools. EOATs and fixtures may be smaller in size where single-sided tools are used, for example as compared to EOATs and fixtures where one or more additional tools are needed on opposite sides or edges of an object. In addition to such single-sided tools, an EOAT may similarly use any of a variety of double-sided tools, including, but not limited to, power clamps, parallel clamps, swing units, and multiple finger or mylar gripping devices, among other mechanical grippers. Further, aspects described herein may be used for any of a variety of other tools, including, but not limited to, drivers, drills, and paint heads, as well as tools for welding, painting, and polishing, among other examples.

An EOAT or fixture may include one or more adjustable assemblies, thereby manipulating or supporting an object using one or more tools associated therewith. For example, an EOAT may have a longitudinal mid-plane along its base along which adjustable assemblies are distributed. In examples, the adjustable assemblies of the EOAT may be positioned such that all tools are on one side of the longitudinal mid-plane, while, in other examples, at least one tool may be on the opposite side of the longitudinal mid-plane. For example, the EOAT may comprise three adjustable assemblies, where two tools are on one side of the longitudinal mid-plane and one tool is on the other side of the longitudinal mid-plane. Such a configuration may enable the EOAT to manipulate a larger object than if all tools were on the same side of the longitudinal mid-plane, by virtue of the increased range of motion (e.g., on both sides of the longitudinal mid-plane rather than a single side).

In examples, an adjustable EOAT or adjustable fixture as described herein is controlled by a controller that configures a set of adjustable assemblies, for example, to manipulate or support an object. The controller may control movement along and/or rotation about the x, y, and/or z axes of each adjustable assembly, thereby positioning an associated tool accordingly. The controller may configure the set of adjustable assemblies for a first object and, subsequently, for a second object. The controller may store one or more configurations for the set of adjustable assemblies (e.g., in association with an object), such that a stored configuration may be retrieved and used to configure the adjustable assemblies accordingly. For example, a stored configuration may define a position and a rotation for a tool along and about the x, y, and z axes. As another example, the stored configuration may define one or more contact points of an object in three-dimensional space, which may be used to generate a position and a rotation for one or more tools of an EOAT accordingly.

In examples, a set of stored configurations may be utilized in a sequence, for example according to an order with which objects are handled on an assembly line. Thus, one or more EOATs and/or fixtures in a series may be configured according to each subsequent object in the sequence as the objects progress down the assembly line. As another example, a configuration may be dynamically selected from the set of stored configurations and applied accordingly. For example, computer vision techniques may be used to identify an object and select an associated configuration accordingly. In another example, such computer vision techniques may be used to dynamically identify one or more locations at which to interact with an object, such that an EOAT and/or fixture may be configured based on the identified locations. Thus, an EOAT may be configured according to a predefined sequence of configurations or dynamically based on an identified object, or any combination thereof.

In some instances, the controller configures a set of adjustable assemblies for an EOAT and a set of adjustable assemblies for a corresponding fixture, such that the EOAT can be used to manipulate an object and place the object on the fixture. The controller may configure an adjustable assembly to be in a retracted or disabled state, such that only a subset of adjustable assemblies is used by the EOAT or fixture. Similarly, the controller may engage or disengage a tool of an adjustable assembly, for example causing the tool to generate or cease generation of a magnetic force or suction force, or extending or retracting a pin of a pin clamp, among other examples.

As a result of the adjustable nature of an EOAT or fixture according to aspects of the present disclosure, it may be possible to transition to handling different objects more quickly, EOATs may be lighter and therefore require less powerful robotic devices, and less space may be needed to house or operate the robotic device as a result in such a reduction in robotic payloads, thereby reducing the overall size of an assembly line, among other benefits. Further, a reduced number of tool stands (e.g., for holding different specialized EOATs) may be provided and fewer fixture stands may be needed in instances where adjustable EOATs and fixtures are used. Additionally, non-valued time may be reduced, as a equipment may spend a lower percentage of time changing tools and a higher percentage of time contributing to value-added processes. As a result of reduced equipment and decreased complexity, higher technical availability may be achieved. Similarly, time to market may be decreased as a result of reduced design and engineering requirements. For instances, simulations may be used to identify robot and/or EOAT movements to adapt an assembly line to manufacture a given object.

In some instances, the controller may further control a robotic device to which the EOAT is mechanically coupled or the controller may be separate from that of a robotic device. One or more image capture devices, light detection and ranging (LIDAR) systems, and/or other machine vision systems and sensors may be used by the controller, for example, to dynamically configure a set of adjustable assemblies based on a detected object. Such sensors may be mounted on the EOAT, the robotic device, and/or external to the EOAT and robotic device, among other examples. Thus, an EOAT need not be restricted to preconfigured object positions. As another example, the controller may identify obstacles and configure an EOAT or fixture so as to avoid a collision or reduce potential damage, among other examples. For example, the controller may model adjustable assemblies and associated movements, such that information of the surrounding environment (e.g., as may be gathered using computer vision techniques and/or LIDAR) may be evaluated to identify potential issues. In embodiments, the tools of the EOAT or fixture itself may be used to assist in determining proximity to the workpiece and/or correctness of the placement of the tool on the workpiece. Additional details are provided in U.S. Pat. No. 10,903,030, US Published Patent Application Nos. US20180311795, and Published PCT Application No. WO2020086791A1, the entire disclosures of which are expressly incorporated by reference herein.

Example computer vision techniques include, but are not limited to, object detection and object tracking. In some instances, sematic segmentation or instance segmentation may be used, for example to determine object boundaries. In some instances, machine learning techniques may be used, for example to detect objects and/or control movement of a robotic device, an adjustable EOAT, an adjustable fixture, and/or one or more constituent adjustable assemblies, linear adjustment subassemblies, or rotational adjustment assemblies. For example, a convolutional neural network or graph neural network may be used for object identification, among other examples. It will be appreciated that the adjustable EOATs and fixtures described herein may be independently controllable or may be controlled in conjunction with one another, among other examples.

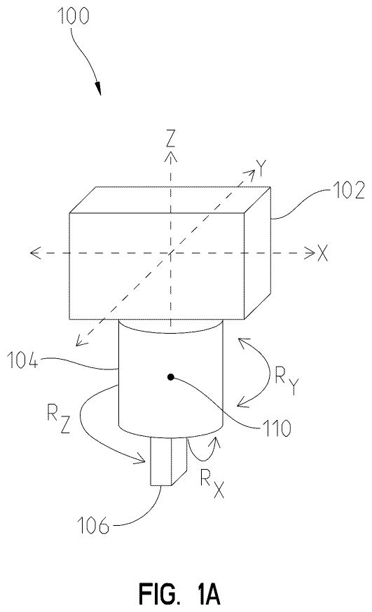

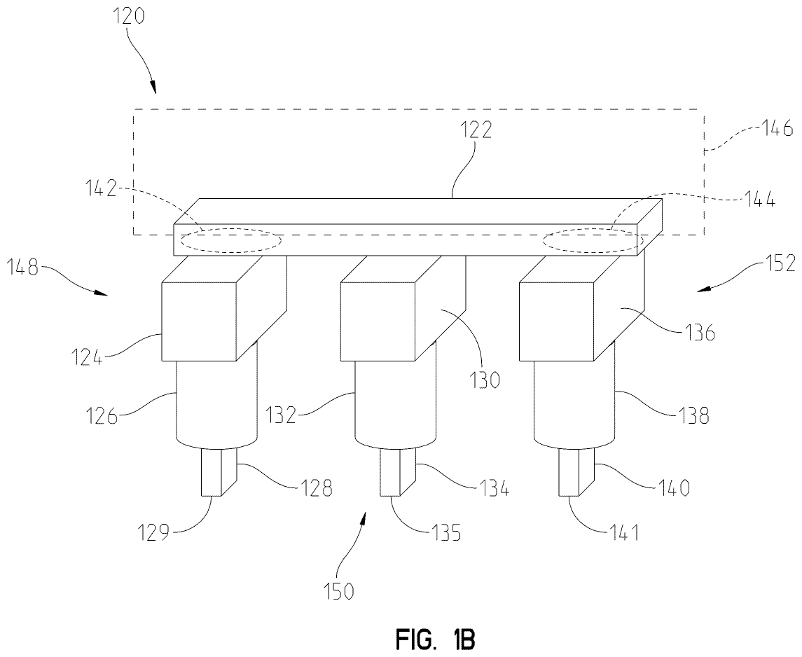

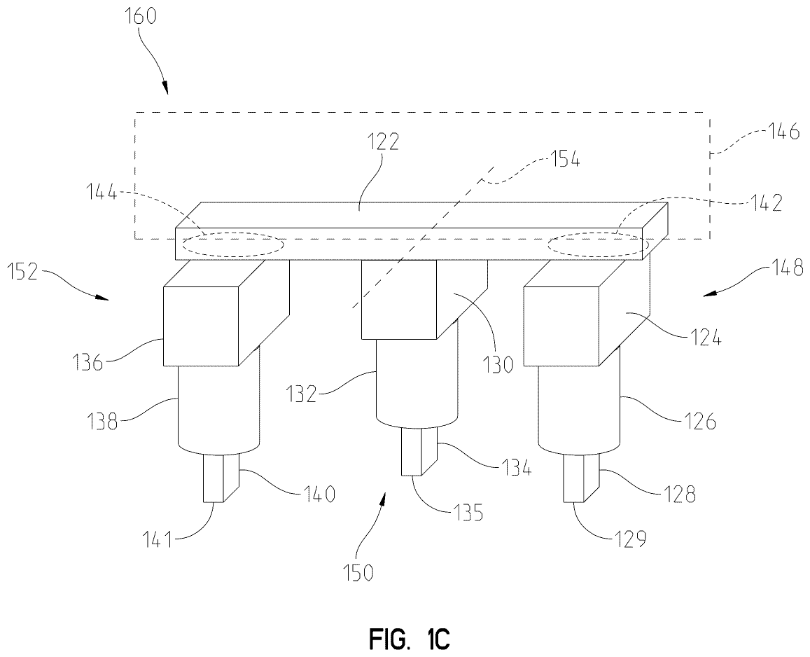

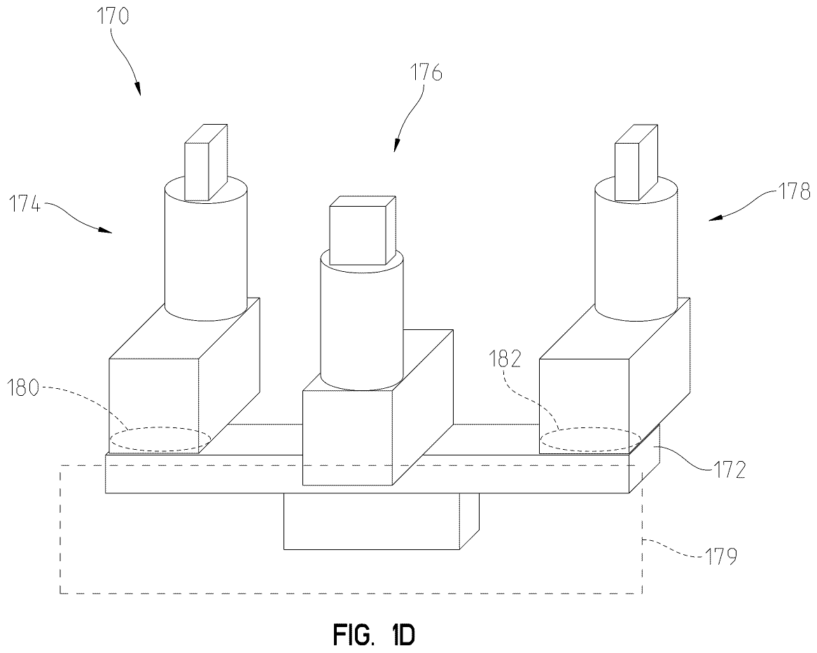

FIG. 1A illustrates a block diagram of a front view of adjustable assembly 1100 for use with an adjustable end-of-arm tool or adjustable fixture. As illustrated, adjustable assembly 1100 comprises linear adjustment subassembly 1102, rotational adjustment subassembly 1104, and tool 1106. The linear adjustment subassembly 1102 and the rotational adjustment subassembly 1104 have a plurality of links and couplers which permit the desired movements of the adjustable assembly 1100 to position tool 1106. As illustrated, linear adjustment subassembly 1102 enables movement along the x, y, and z axes. Rotational adjustment subassembly 1104 is mechanically coupled to linear adjustment subassembly 1102, such that movement by linear adjustment subassembly 1102 adjusts the position of rotational adjustment subassembly 1104 accordingly.

Further, the grouping of translational movements (linear movements) in one sub-assembly and rotational movements (angular movements) in another sub-assembly is for the ease of the reader, not due to a requirement that they be in separate sub-assemblies. On the contrary, it is possible, in embodiments to have a given sub-assembly that provides both translational and rotational motion. As another example, rotational mounts may couple links of a sub-assembly together, thereby enhancing the modularity and range of motion of the sub-assembly, as may be beneficial in instances where multiple adjustable assemblies 1100 are used.

Rotational adjustment subassembly 1104 is illustrated as enabling rotational movement about the x, y, and z axes. It will be appreciated that a given point of rotation 1110 may occur in the center of rotational adjustment assembly 1104, at an end portion of the rotational adjustment assembly, and/or at an attachment point of tool 1106, among other examples. In embodiments, rotational adjustment assembly 1104 may be coupled to linear adjustment subassembly in a way wherein rotation is not about the x, y, and z axes, but rather about three orthogonal axes (a fourth axis, a fifth axis, and a sixth axis) that are rotated relative to at least two of the x, y, and z axes. However, in examples the fourth axis, the fifth axis, and the sixth axis do coincide with the x, y, and z axes.

In embodiments, rotational adjustment assembly 1104 is a wrist joint having a frame and an output interface supported by the frame. The tool 1106 is coupled to the output interface. The output interface may be rotated about the z-axis with a hydraulic motor, stepper motor, or other suitable device which rotates the frame relative to the linear adjustment subassembly 1102. Along with the output interface, a control assembly for rotation about the y-axis and a control assembly for rotation about the x-axis are rotated about the z-axis. The control assembly for rotation about the y-axis may include a first ring that surrounds the z-axis and which is pivotably connected to the frame. The pivot axis between the frame and the first ring corresponds to the y-axis. The angular position of the first ring relative to the frame may be controlled with a hydraulic cylinder coupled between the frame and the first ring at a location spaced apart from the pivots between the frame and first ring. The first ring carries the control assembly for rotation about the x-axis and the output interface. As such, a rotation of the first ring about the y-axis causes a corresponding rotation of the output interface and hence the tool about the y-axis. The control assembly for rotation about the x-axis may include a second ring that surrounds the z-axis and which is pivotably connected to the first ring of the y-axis control assembly. The pivot axis between the first ring and the second ring corresponds to the x-axis. The angular position of the second ring relative to the first ring may be controlled with a hydraulic cylinder coupled between the first ring and the second ring at a location spaced apart from the pivots between the first ring and the second ring. The second ring carries the output interface. As such, a rotation of the second ring about the x-axis causes a corresponding rotation of the output interface and hence the tool about the x-axis. In embodiments, the pivot axis between the frame and first ring for the control assembly for rotation about the y-axis and the pivot axis between the first ring and the second ring for the control assembly for rotation about the x-axis intersect each other. In embodiments, the pivot axis between the frame and first ring for the control assembly for rotation about the y-axis and the pivot axis between the first ring and the second ring for the control assembly for rotation about the x-axis intersect each other and intersect the rotation axis of the frame about the z-axis, shown as point 1110 in FIG. 1A. An exemplary wrist joint is disclosed in Chinese Patent No. CN110171015B.

Thus, linear adjustment subassembly 1102 and rotational adjustment subassembly 1104 are usable to adjust the position of tool 1106 along and about the x, y, and z axes. As described above, tool 1106 may be a gripper or a locator, among other examples. In some instances, tool 1106 may be removable from rotational adjustment assembly 1104, such that tool 1106 is mechanically coupled at an attachment point of rotational adjustment assembly 1104.

FIGS. 1B and 1C illustrate block diagrams of a front view 1120 and a back view 1160, respectively, of an adjustable end-of-arm tool 1122 having multiple adjustable assemblies 1148, 1150, and 1152 in various configurations according to aspects of the present disclosure.

EOAT 1122 comprises adjustable assembly 1148 (e.g., comprising linear adjustment subassembly 1124, rotational adjustment subassembly 1126, and tool 1128), adjustable assembly 1150 (e.g., comprising linear adjustment subassembly 1130, rotational adjustment subassembly 1132, and tool 1134), and adjustable assembly 1152 (e.g., comprising linear adjustment subassembly 1136, rotational adjustment subassembly 1138, and tool 1140). The respective linear adjustment subassemblies 1124, 1130, and 1136 and the respective rotational adjustment subassemblies 1126, 1132, and 1138 each have a plurality of links and couplers which permit the desired movements of the respective adjustable assembly 1148, 1150, and 1152 to position respective tool 1128, 1134, and 1140. In embodiments, the interfaces 1129, 1135, and 1141 of tools 1128, 1134, and 1140 of EOAT 1122 may form a plane via which an object can be manipulated. In embodiments, at least two of the interfaces 1129, 1135, and 1141 of tools 1128, 1134, and 1140 of EOAT 1122 are non-planer due to either a translation of one of tools relative to the other and/or a rotation of one of the tools relative to the other. It will be appreciated that, in other examples, interfaces 1129, 1135, and 1141 may be planar. In examples, tools 1128, 1134, and 1140 need not be the same type of tool. For example, tools 1128 and 1140 may be magnetic grippers, while tool 1134 may be a locating pin.

As illustrated in view 1120, EOAT 1122 is in a configuration where adjustable assemblies 1148, 1150, and 1152 are distributed along longitudinal mid-plane 1146 such that tools 1128, 1134, and 1140 are all on one side of longitudinal mid-plane 1146. EOAT 1122 is further illustrated as including rotation mounts 1142 and 1144, such that adjustable assemblies 1148 and/or 1152 may be rotated to achieve alternate configurations. View 1160 in FIG. 1C illustrates such an alternate configuration of EOAT 1122, where adjustable assemblies 1148 and 1152 are configured to position tools 1128 and 1140 on the opposite side of longitudinal mid-plane 1146 as compared to adjustable assembly 1150 and its associated tool 1134. In addition to the illustrated rotation, rotation mounts 1142 and 1144 may be linearly translatable along longitudinal mid-plane 1146 to adjust the position of tools 1128 and 1140 along longitudinal mid-plane 1146 with respect to tool 1134.

Such a configuration may offer a deeper range of motion (e.g., along axis 1154) as compared to that of the configuration in view 1120. In other configurations, an adjustable assembly may be configured to be in line with longitudinal mid-plane 1146, such that the configuration of tools 1128, 1134, and 1140 is wider (e.g., along axis 1146) than the configurations illustrated in views 1120 and 1160. It will be appreciated that, in other examples, rotation mounts 1142 and/or 1144 may be omitted, such that adjustable assemblies 1148 and 1152, respectively, are fixably attached to EOAT 1122, similar to adjustable assembly 1150. In other examples, any number of adjustable assemblies and/or rotation mounts may be used.

FIG. 1D illustrates a block diagram of a front view of an adjustable fixture 1170 having multiple adjustable assemblies. Aspects of adjustable fixture 1170 are similar to EOAT 1122 and are therefore not necessarily re-described in detail. For example, EOAT 1122 is illustrated as comprising adjustable assemblies 1174, 1176, and 1178, which are similar to those discussed above with respect to FIGS. 1A-1C.

Similar to EOAT 1122, base 1172 of adjustable fixture 1170 comprises rotation mounts 1180 and 1182, such that adjustable assemblies 1174 and 1178 may be rotated for configurations where one or more of adjustable assemblies 1174, 1176, and 1178 are on the same or different sides of a longitudinal mid-plane 1179 of adjustable fixture 1170. As discussed above, adjustable fixture 1170 may be used to support an object, as may be placed on adjustable fixture 1170 using an adjustable EOAT, such as EOAT 1122 discussed above. Thus, both adjustable fixture 1170 and EOAT 1122 may be configured by a controller to support and manipulate, respectively, the same object.

FIGS. 2A-2D illustrate example views 1200, 1220, 1240, and 1260 of a robotic device 1202 having an adjustable end-of-arm tool (e.g., comprising linear adjustment subassembly 1210, rotational adjustment subassembly 1204, and tool 1212) manipulating multiple objects 1208 and 1262 according to aspects described herein. Although the EOAT is illustrated with a single adjustable assembly, the EOAT may have two or more adjustable assemblies each having translational and/or rotational adjustability.

Thus, in addition to the tool adjustment aspects described above with respect to an adjustable assembly, an EOAT itself may be moved. As an example, the EOAT may be configured according to a stored configuration associated with objects 1208 or objects 1262, such that robotic device 1202 may then move the EOAT to manipulate objects 1208 or objects 1262 accordingly.

For example, as compared to view 1200, view 1220 depicts the EOAT in a configuration to manipulate objects 1208. As illustrated, rotational adjustment subassembly 1204 has been configured to rotate tool 1212 in such a way that it may manipulate objects 1208. In some examples, linear adjustment subassembly 1210 may similarly move tool 1212 along one or more axes, for example to better access objects 1208 in container 1206.

Accordingly, robotic device 1202 may move the adjustable EOAT into container 1206, at which point a controller may engage tool 1212 to manipulate object 1214 of objects 1208 accordingly. For example, tool 1212 may be a magnetic gripper or a suction gripper, such that tool 1212 is used to generate magnetic or suction force. In some examples, the EOAT may remain in a substantially similar configuration for the duration that it is used by robotic device 1202 to manipulate object 1214. In other instances, linear adjustment subassembly 1210 and/or rotational adjustment subassembly 1204 may be reconfigured while tool 1212 is gripping object 1214. For example, linear adjustment subassembly 1210 may move tool 1212 along one or more of the x, y, or z axes in addition to or as an alternative to movement by robotic device 1202. Thus, it will be appreciated that robotic device 1202 and the EOAT may operate in concert to manipulate object 1214.

View 1260 similarly illustrates robotic device 1202 using EOAT to manipulate objects 1262 using tool 1212. In examples, the EOAT is configured according to a stored configuration associated with objects 1262, for example, from a previous configuration for objects 1208. In some instances, computer vision, a LIDAR system, or other sensor information is used to identify objects 1208 and/or objects 1262 within container 1206, such that the EOAT may be dynamically configured to manipulate objects 1208 and/or 1262 accordingly. For example, the EOAT may be configured based on the sensor information (e.g., absent pre-existing configuration information for objects 1208 and/or 1262) or an associated configuration may be adapted according to the sensor information, for example to account for variations in the position of objects 1208 and/or 1262.

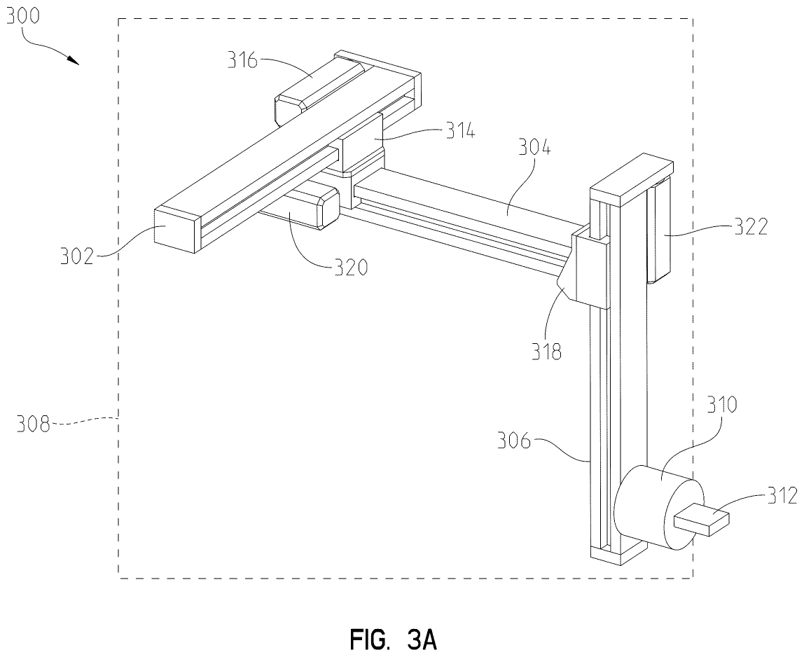

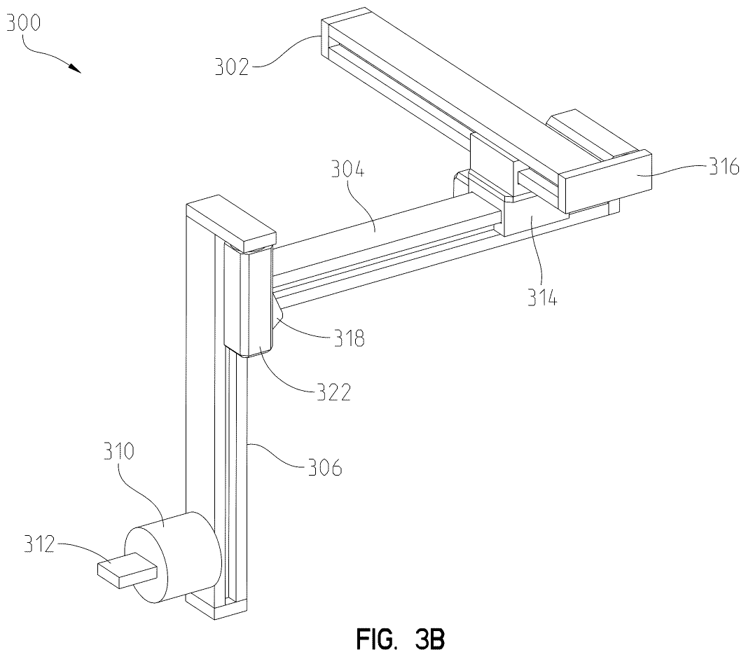

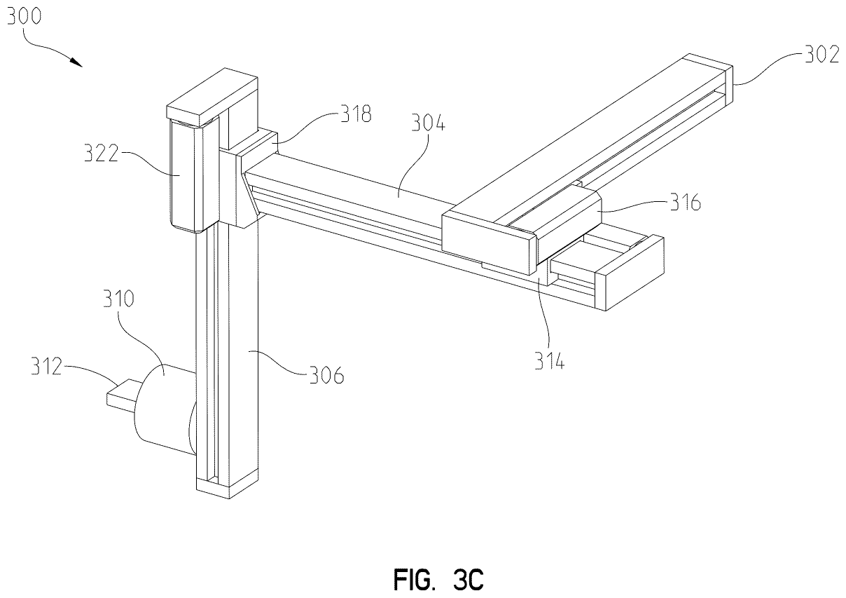

FIG. 3A illustrates a front left view of an example adjustable assembly 1300, while FIG. 3B illustrates a front right view and FIG. 3C illustrates a rear left view. As illustrated, adjustable assembly 1300 comprises linear adjustment subassembly 1308, rotational adjustment subassembly 1310, and tool 1312. The linear adjustment subassembly 1308 and the rotational adjustment subassemblies 1310 each have a plurality of links and couplers which permit the desired movements of the adjustable assembly 1300 to position the tool 1312. Linear adjustment subassembly 1308 is illustrated as comprising linear rails 1302, 1304, and 1306. As illustrated, slidable coupler 1314 slides along linear rail 1302 and linear rail 1304, while slidable coupler 1322 slides along linear rail 1306. Thus, in the instant example, slidable coupler 1314 enables movement along two perpendicular axes (e.g., that of linear rails 1302 and 1304; the x and y axes), while slidable coupler 1318 enables movement along one axis perpendicular to those of slidable coupler 1314 (e.g., that of linear rail 1306; the z axis).

Linear adjustment subassembly 1308 is further depicted as comprising motors 1316, 1320, and 1322. As illustrated, motor 1316 causes movement along linear rail 1302, motor 1320 causes movement along linear rail 1304, and motor 1322 causes movement along linear rail 1306. In examples, motors 1316, 1320, and 1322 each comprise a rotary encoder, such that the positions along linear rails 1302, 1304, and 1306 may be determined. For example, the location of coupler 1314 may be determined relative to linear rail 1302 by a rotary encoder of motor 1316, while the location of coupler 1314 along linear rail 1304 may be determined by a rotary encoder of motor 1320. Similarly, the location of coupler 1318 along linear rail 1306 may be determined by motor 1322. It will be appreciated that such aspects are provided as an example and, in other examples, any of a variety of additional or alternative techniques may be used to determine the current configuration of linear adjustment subassembly 1308. Such feedback may similarly be provided by rotational adjustment subassembly 1310. For example, an absolute encoder may be used (e.g., for each axis), such that homing after an interruption in power may be not be required. Further, data from absolute encoders of an adjustable assembly may be used by a controller (e.g., controller 1050) to store a configuration of the adjustable assembly for subsequent use.

Adjustable assembly 1300 is further illustrated as comprising rotational adjustment assembly 1310 and tool 1312, aspects of which are similar to those discussed above with respect to FIGS. 1A-1D and 2A-2D, and are therefore not necessarily re-described in detail. As noted above, rotational adjustment assembly 1310 may enable rotation about the x, y, and z axis, such that tool 1312 may be rotated accordingly.

It will be appreciated that the location at which rotational adjustment assembly 1310 is affixed to linear rail 1306 is provided as an example. As another example, rotational adjustment assembly 1310 may be affixed to the end of linear rail 1306 or, as a further example, rather than moving linear rail 1306 with respect to slidable coupler 1318, linear rail 1306 may be fixably coupled to linear rail 1304 and motor 1322 may be configured to move rotational adjustment assembly 1310 along linear rail 1306 instead.

FIG. 4A illustrates a top perspective view of an adjustable end-of-arm tool 1400 having multiple adjustable assemblies according to aspects of the present disclosure, while FIG. 4B illustrates a bottom perspective view and FIG. 4C illustrates another top perspective view. For example, EOAT 1400 may be used by a robotic device, such as robotic device 1202 discussed above with respect to FIGS. 2A-2D. In such instances, common linear rail 1402 may comprise a mechanism with which EOAT 1400 may be mechanically coupled to robotic device 1202. Aspects of EOAT 1400 may be similar to that of EOAT 1122 discussed above with respect to FIGS. 1B-1C and are therefore not necessarily re-described below in detail. Further, while FIGS. 4A-4C depict an EOAT 1400, it will be appreciated that similar aspects are applicable to an adjustable fixture, similar to adjustable fixture 1170 discussed above with respect to FIG. 1D.

As illustrated, EOAT 1400 comprises adjustable assemblies 1434, 1436, and 1438. Adjustable assembly 1434 is illustrated as comprising slidable coupler 1404, linear rail 1406, slidable coupler 1408, linear rail 1410, and rotatable adjustment subassembly 1412. Adjustable assembly 1436 is illustrated as comprising slidable coupler 1414, linear rail 1416, slidable coupler 1418, linear rail 1420, and rotatable adjustment subassembly 1422. Adjustable assembly 1438 is illustrated as comprising slidable coupler 1424, linear rail 1426, slidable coupler 1428, linear rail 1430, and rotatable adjustment subassembly 1432.

As compared to adjustable assembly 1300 discussed above with respect to FIGS. 3A-3C, adjustable assemblies 1434, 1436, and 1438 have a base including a common linear rail 1402 on which slidable couplers 1404, 1414, and 1424 move along longitudinal mid-plane 1440. Adjustable assemblies 1434, 1436, and 1438 each further comprise linear rails 1406, 1416, and 1426 that are coupled to slidable couplers 1404, 1414, or 1424, respectively, such that each adjustable assembly may position a respective tool along linear rails 1406, 1416, and 1426 accordingly. Although the base is shown as having a single linear rail, in embodiments, base includes multiple rails, each supporting one or more of the adjustable assemblies.

The illustrated example EOAT 1400 is a configuration in which all adjustable assemblies 1434, 1436, and 1438 are on the same side of longitudinal mid-plane 1440 (e.g., similar to the configuration illustrated in view 1120 discussed above with respect to FIG. 1B). In some instances, EOAT 1400 may further comprise one or more rotation mounts, such that an adjustable assembly may be rotated perpendicular to longitudinal mid-plane 1440, similar to the aspects discussed above with respect to view 1160 of FIG. 1C. As another example, an adjustable assembly may be fixably attached in another configuration (e.g., rotated 90 or 180 degrees).

FIG. 5A illustrates a perspective view 1500 of a robotic device 1502 having an adjustable end-of-arm tool 1536 according to aspects of the present disclosure. Aspects of robotic device 1502 and EOAT 1536 may be similar to those discussed above and may therefore not necessarily be re-described in detail below. For example, EOAT 1536 may be similar to that of EOAT 1400 discussed above with respect to FIGS. 4A-4C.

As illustrated, robotic device 1502 is configured to move EOAT 1536 above a variety of axes 1540, 1542, 1544, and 1546. Thus, tools 1512 and 1522 may be moved about such axes in addition to or as an alternative to movement by adjustable assemblies 1548 and 1550 according to aspects described herein. As illustrated, adjustable assembly 1548 comprises linear rail 1506, linear rail 1508, rotational adjustment subassembly 1510, tool 1512, and contact point 1514. Similarly, adjustable assembly 1550 comprises linear rail 1516, linear rail 1518, rotational adjustment subassembly 1520, tool 1522, and contact point 1524. Similar to EOAT 1400 discussed above with respect to FIGS. 4A-4C, EOAT 1536 comprises common linear rail 1504 along which adjustable assemblies 1548 and/or 1550 may move. For example, common linear rail 1504 may enable movement of tools 1512 and 1522 along the x-axis, while linear rails 1506 and 1516 may enable movement along the z-axis and linear rails 1508 and 1518 may enable movement along the y-axis.

While examples are described herein with a configuration of linear rails offering movement in a given order of axes, it will be appreciated that a linear adjustment subassembly may have any of a variety of other arrangements. For example, FIGS. 3A-3C illustrate an instance where a first linear rail 1302 enables movement along the x-axis, a second linear rail 1304 enables movement along the y-axis, and a third linear rail 1306 enables movement along the z-axis, while FIGS. 5A-5B illustrate an instance where a first linear rail 1504 enables movement along the x-axis, a second linear rail 1506 enables movement along the z-axis, and a third linear rail 1508 enables movement along the y-axis. Further, other examples need not restrict movement axes that are perpendicular to one another.

As discussed above, adjustable assemblies 1548 and 1550 of EOAT 1536 may be configured for manipulation of any of a variety of objects. In examples, EOAT 1536 is configured independent of movement by robotic device 1502, such that EOAT 1536 is configured to manipulate an object (e.g., thereby enabling robotic device 1502 to grip the object), while robotic device 1502 moves EOAT 1536 (and, when interfaces 1514 and 1524 are engaged, an object associated therewith) about one or more of axes 1540, 1542, 1544, and 1546. Such movements need not be mutually exclusive, such that robotic device 1502 may move toward an object while EOAT 1536 is configured to manipulate the object at least partially contemporaneously with the movement of robotic device 1502.

In other instances, adjustable assemblies 1548 and 1550 may be operated in conjunction with movement of robotic device 1502, such that the object is moved as a result of a combination of movement by robotic device 1502 and EOAT 1536. In such instances, the positions of tools 1512 and 1522 may remain substantially fixed with respect to one another, even while there is movement along and/or rotation about the x, y, and/or z axes.

FIG. 5B illustrates a perspective view 1560 of a robotic device 1502 having another adjustable end-of-arm tool 1538 according to aspects of the present disclosure. As compared to EOAT 1536 discussed above with respect to FIG. 5A, EOAT 1538 has an additional adjustable assembly 1552 comprising linear rail 1526 for movement along the z-axis, linear rail 1528 for movement along the y-axis, rotational adjustment subassembly 1530 for rotation about the x, y, and z axes, tool 1532, and contact point 1534. Thus, it will be appreciated that an EOAT may include any number of adjustable assemblies, for example according to the weight to be lifted using the EOAT or the range needed to grip an object, among other examples. In some examples, an adjustable assembly may be disabled for certain objects. For example, EOAT 1538 may be used similar to EOAT 1536 in some instances, where adjustable assembly 1552 may be retracted or otherwise moved such that tool 1532 is not in contact with an object that is otherwise contacted at contact points 1514 and 1524 of tools 1512 and 1522, respectively. In instances where an EOAT includes multiple adjustable assemblies, each adjustable assembly may comprise a set of sensors used by a controller (e.g., controller 1050) to prevent or mitigate crashes that may occur among the multiple adjustable assemblies (e.g., between adjustable assemblies 1548, 1550, and/or 1552).

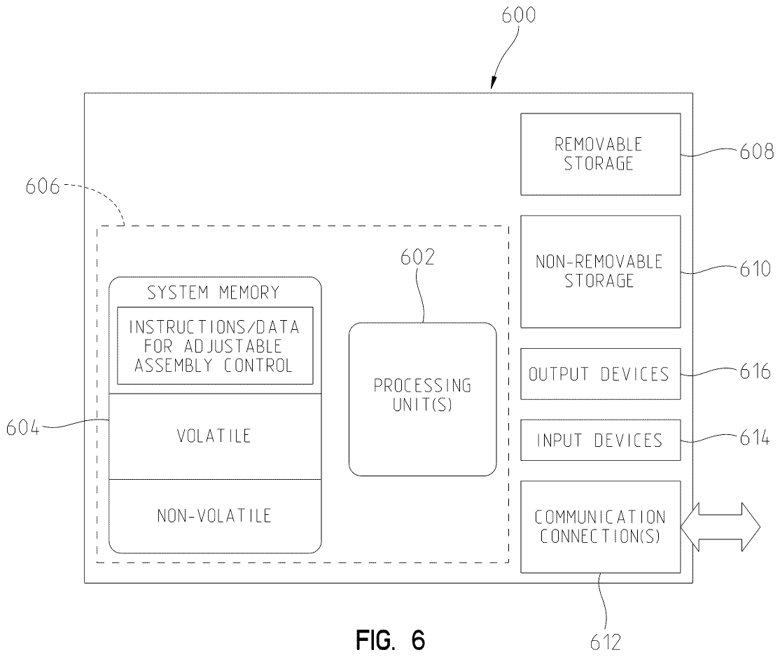

FIG. 6 illustrates an example of a suitable operating environment 1600 of electronic controller 1050 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In examples, operating environment 1600 may be part of a robotic device, an adjustable EOAT, an adjustable fixture, or an adjustable assembly, or any combination thereof according to the aspects described herein. In other examples, operating environment 1600 may be a separate computing device, for example that is in communication with one or more robotic devices, adjustable EOATs, adjustable fixtures, and/or associated adjustable assemblies.

In its most basic configuration, operating environment 1600 typically may include at least one processing unit 1602 and memory 1604. Depending on the exact configuration and type of computing device, memory 1604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 1606. Further, environment 1600 may also include storage devices (removable, 1608, and/or non-removable, 1610) including, but not limited to, magnetic or optical disks or tape. Similarly, environment 1600 may also have input device(s) 1614 such as a keyboard, mouse, pen, voice input, etc. and/or output device(s) 1616 such as a display, speakers, printer, etc. Also included in the environment may be one or more communication connections, 1612, such as LAN, WAN, point to point, etc.

Operating environment 1600 may include at least some form of computer readable media. The computer readable media may be any available media that can be accessed by processing unit 1602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 1600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet. In aspects, networking environments may include industrial ethernet networks and/or discrete I/O communications.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 1604. While executing on the processing unit 1602, program modules (e.g., applications, Input/Output (I/O) management, and other utilities) may perform processes including, but not limited to, control of an adjustable EOAT, an adjustable fixture, and/or robotic device in accordance with the aspects described above.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 1600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

### EXAMPLES

Example 1. An adjustable end-of-arm tool for a robot may comprise a base adapted to be coupled to the robot; a first adjustable assembly coupled to the base; and a second adjustable assembly coupled to the base. The first adjustable assembly may comprise a first plurality of links; a first plurality of couplers coupling the plurality of links and the base, the first plurality of couplers may provide at least two degrees of the freedom; and a first tool coupled to the base through the first plurality of links and the first plurality of couplers. The first tool may include a first interface which is positionable relative to the base in multiple positions based on the first plurality of links and the first plurality of couplers. The second adjustable assembly may comprise a second plurality of links; a second plurality of couplers coupling the plurality of links and the base, the first plurality of couplers may provide at least two degrees of the freedom; and a second tool coupled to base through the second plurality of links and the second plurality of couplers. The second tool may include a second interface which is positionable relative to the base in multiple positions based on the second plurality of links and the second plurality of couplers.

Example 2. The adjustable end-of-arm tool of Example 1, wherein at least one of the first tool and the second tool may be a magnetic gripper.

Example 3. The adjustable end-of-arm tool of Example 1, wherein the base may have a longitudinal mid-plane. The first adjustable assembly may be positioned on a first side of the longitudinal mid-plane and the second adjustable assembly may be positioned on a second side of the longitudinal mid-plane, the second side being opposite the first side.

Example 4. The adjustable end-of-arm tool of any of Examples 1-3, wherein the base may include a linear rail defining a first axis.

Example 5. The adjustable end-of-arm tool of Example 4, wherein the first plurality of couplers may enable linear movement along the first axis, may enable linear movement along a second axis perpendicular to the first axis, and may enable linear movement along a third axis perpendicular to both the first axis and the second axis.

Example 6. The adjustable end-of-arm tool of Example 5, the first plurality of links may include a first linear rail parallel to the second axis and slidably coupled to the linear rail; and a second linear rail parallel to the third axis and slidably coupled to the first linear rail.

Example 7. The adjustable end-of-arm tool of any of the previous Examples, wherein the first plurality of couplers may enable rotation about at least one of the first axis, the second axis, and the third axis.

Example 8. The adjustable end-of-arm tool of Example 7, wherein the first plurality of couplers may enable rotation about at least two of the first axis, the second axis, and the third axis.

Example 9. The adjustable end-of-arm tool of Example 8, wherein the first plurality of couplers may enable rotation about each of the first axis, the second axis, and the third axis.

Example 10. The adjustable end-of-arm tool of Example 1, wherein the first tool and the second tool may each be a single-sided tool.

Example 11. The adjustable end-of-arm tool of Example 10, wherein the single-sided tool may be one of: a magnetic gripper; a suction gripper; a pin clamp; or a locator.

Example 12. The adjustable end-of-arm tool of Example 1, wherein the first tool and the second tool may each be a double-sided tool.

Example 13. The adjustable end-of-arm tool of Example 12, wherein the double-sided tool may be one of: a power clamp; a parallel clamp; a swing unit; a multiple finger gripping device; or a mylar gripping device.

Example 14. The adjustable end-of-arm tool of Example 1, may further comprise a third adjustable assembly coupled to the base. The third adjustable assembly may comprise a third plurality of links; a third plurality of couplers coupling the third plurality of links and the base, the third plurality of couplers may provide at least two degrees of the freedom; and a third tool coupled to the base through the third plurality of links and the third plurality of couplers.

Example 15. The adjustable end-of-arm tool of Example 14, wherein the base may have a longitudinal mid-plane. The first adjustable assembly and the third adjustable assembly may be positioned on a first side of the longitudinal mid-plane and the second adjustable assembly may be positioned on a second side of the longitudinal mid-plane, the second side being opposite the first side.

Example 16. The adjustable end-of-arm tool of any one of Examples 13 and 14, wherein the first plurality of links and the first plurality of couplers may provide six degrees of freedom for the positioning the first tool relative to the base, the second plurality of links and the second plurality of couplers may provide six degrees of freedom for the positioning the second tool relative to the base, and the third plurality of links and the third plurality of couplers may provide six degrees of freedom for the positioning the third tool relative to the base.

Example 17. The adjustable end-of-arm tool of Example 16, wherein each of the first adjustable assembly, the second adjustable assembly, and the third adjustable assembly may be independently coupled to the base.

Example 18. The adjustable end-of-arm tool of Example 1, wherein the first plurality of links and the first plurality of couplers may provide six degrees of freedom for the positioning the first tool relative to the base and the second plurality of links and the second plurality of couplers may provide six degrees of freedom for the positioning the second tool relative to the base.

Example 19. The adjustable end-of-arm tool of Example 18, wherein each of the first adjustable assembly and the second adjustable assembly may be independently coupled to the base.

Example 20. The adjustable end-of-arm tool any of the previous Examples, may further comprise a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base.

Example 21. The adjustable end-of-arm tool of Example 20, wherein the controller may be further configured to: identify a second configuration associated with a second object, wherein the second configuration is different than the first configuration; and configure the first adjustable assembly and the second adjustable assembly according to the second configuration to position the first interface of first tool in a third position relative to the base and to position the second interface of the second tool in a fourth position relative to the base.

Example 22. An adjustable fixture to receive an object may comprise a base; a first adjustable assembly coupled to the base; and a second adjustable assembly coupled to the base. The first adjustable assembly may comprise a first plurality of links; a first plurality of couplers coupling the first plurality of links and the base, the first plurality of couplers providing at least two degrees of the freedom; and a first tool coupled to the base through the first plurality of links and the first plurality of couplers. The first tool may include a first interface extending above the base. The first interface may be positionable relative to the base in multiple positions based on the first plurality of links and the first plurality of couplers. The second adjustable assembly may comprise a second plurality of links; a second plurality of couplers coupling the second plurality of links and the base, the second plurality of couplers providing at least two degrees of the freedom; and a second tool coupled to base through the second plurality of links and the second plurality of couplers. The second tool may include a second interface extending above the base. The second interface being positionable relative to the base in multiple positions based on the second plurality of links and the second plurality of couplers.

Example 23. The adjustable fixture of Example 22, wherein the first tool and the second tool may each be a single-sided tool.

Example 24. The adjustable fixture of Example 23, wherein the single-sided tool may be one of: a magnetic gripper; a suction gripper; a pin clamp; or a locator.

Example 25. The adjustable fixture of Example 22, wherein the first tool and the second tool may each be a double-sided tool.

Example 26. The adjustable fixture of any one of Examples 22-25, may further comprise a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base.

Example 27. The adjustable fixture of Example 26, wherein the first configuration associated with the first object may be identified according to a sequence comprising the first object and a second object. The controller may be further configured to: identify a second configuration associated with the second object according to the sequence; and configure the first adjustable assembly and the second adjustable assembly according to the second configuration to position the first interface of first tool in a third position relative to the base and to position the second interface of the second tool in a fourth position relative to the base.

Example 28. The adjustable fixture of Example 22, wherein the first plurality of links and the first plurality of couplers may provide six degrees of freedom for the positioning the first tool relative to the base and the second plurality of links and the second plurality of couplers may provide six degrees of freedom for the positioning the second tool relative to the base.

Example 29. The adjustable fixture of Example 28, wherein each of the first adjustable assembly and the second adjustable assembly may be independently coupled to the base.

Example 30. A method for controlling an adjustable assembly of an EOAT for a robot may comprise identifying a first configuration associated with a first object; configuring the adjustable assembly according to the first configuration wherein an interface of the adjustable assembly has a first position relative to a base of the adjustable assembly; engaging a tool of the adjustable assembly, thereby causing the adjustable assembly to grip the first object; disengaging the tool of the adjustable assembly; identifying a second configuration associated with a second object; configuring the adjustable assembly according to the second configuration wherein an interface of the adjustable assembly has a second position relative to a base of the adjustable assembly, the second position being different than the first position; engaging the tool of the adjustable assembly, thereby causing the adjustable assembly to grip the second object; and disengaging the tool of the adjustable assembly.

Example 31. The method of Example 30, wherein the first configuration associated with the first object may be identified according to a stored sequence comprising the first object and the second object; and the second configuration associated with the second object may be identified according to the stored sequence.

Example 32. The method of Example 30, wherein the first configuration associated with the first object may be identified in response to detecting the first object using computer vision;

and the second configuration associated with the second object may be identified in response to detecting the second object using computer vision.

Example 33. The method of Example 30, wherein configuring the adjustable assembly according to the first configuration may comprise detecting the first object using computer vision; and dynamically configuring the adjustable assembly based on the detected first object.

Example 34. The method of Example 30, wherein configuring the adjustable assembly according to the first configuration may comprise identifying a location of the first object using computer vision; and configuring the interface of the adjustable assembly according to the identified location.

Example 35. A method for controlling an adjustable assembly of an EOAT for a robot may comprise identifying a first configuration associated with a first object; configuring the adjustable assembly according to the first configuration wherein a first interface of a first tool of the adjustable assembly may have a first position relative to the base, a second interface of a second tool of the adjustable assembly may have a second position relative to the base, and a third interface of a third tool of the adjustable assembly may have a third position relative to the base; engaging the plurality of tools of the adjustable assembly, thereby causing the adjustable assembly to grip the first object; disengaging the plurality of tool of the adjustable assembly; identifying a second configuration associated with a second object; configuring the adjustable assembly according to the second configuration wherein at least one of the first interface of the first tool, the second interface of the second tool, and the third interface of the third tool is moved relative to the first configuration; engaging the plurality of tools of the adjustable assembly, thereby causing the adjustable assembly to grip the second object; and disengaging the plurality of tools of the adjustable assembly. The adjustable assembly may include a base, a plurality of tools including the first tool having the first interface, the second tool having the second interface, and the third tool having the third interface. The first interface of the first tool may be moveable relative to the base in six degrees of freedom. The second interface of the second tool may be moveable relative to the base in six degrees of freedom. The third interface of the third tool may be moveable relative to the base in six degrees of freedom.

Example 36. The method of Example 35, wherein the first configuration associated with the first object may be identified according to a stored sequence comprising the first object and the second object; and the second configuration associated with the second object may be identified according to the stored sequence.

Example 37. The method of Example 35, wherein the first configuration associated with the first object may be identified in response to detecting the first object using computer vision; and the second configuration associated with the second object is identified in response to detecting the second object using computer vision.

Example 38. The method of Example 35, wherein configuring the adjustable assembly according to the first configuration may comprise detecting the first object using computer vision; and dynamically configuring the adjustable assembly based on the detected first object.

Example 39. The method of Example 35, wherein configuring the adjustable assembly according to the first configuration may comprise identifying a location of the first object using computer vision; and configuring the interface of the adjustable assembly according to the identified location.

Example 40. An adjustable end-of-arm tool for a robot may comprise a base adapted to be coupled to the robot, the base including a linear rail defining a first axis; a first adjustable assembly coupled to the base; and a second adjustable assembly coupled to the base. The first adjustable assembly may comprise a first plurality of links; a first plurality of couplers coupling the plurality of links and the base, and a first tool. The first plurality of couplers may enable linear movement along the first axis, may enable linear movement along a second axis perpendicular to the first axis, may enable linear movement along a third axis perpendicular to both the first axis and the second axis, and may enable rotation about at least two of a fourth axis, a fifth axis, and a sixth axis. The first tool may be coupled to the base through the first plurality of links and the first plurality of couplers. The first tool may include a first interface which is positionable relative to the base in multiple positions based on the first plurality of links and the first plurality of couplers. The second adjustable assembly may be coupled to the base. The second adjustable assembly may comprise a second plurality of links; a second plurality of couplers coupling the plurality of links and the base, the second plurality of couplers may provide at least two degrees of the freedom; and a second tool. The second tool may be coupled to base through the second plurality of links and the second plurality of couplers. The second tool may include a second interface which is positionable relative to the base in multiple positions based on the second plurality of links and the second plurality of couplers.

Example 41. The adjustable end-of-arm tool of Example 40, wherein the first plurality of couplers may enable rotation about each of the fourth axis, the fifth axis, and the sixth axis.

Example 42. The adjustable end-of-arm tool of any one of Examples 40 and 41, wherein the fourth axis may be the first axis, the fifth axis may be the second axis, and the sixth axis may be the third axis.

Example 43. The adjustable fixture of Example 40, wherein each of the first adjustable assembly and the second adjustable assembly may be independently coupled to the base.

Example 44. The adjustable end-of-arm tool of Example 43, may further comprise a third adjustable assembly coupled to the base. The third adjustable assembly may comprise a third plurality of links; a third plurality of couplers coupling the third plurality of links and the base, the third plurality of couplers providing at least two degrees of the freedom; and a third tool coupled to the base through the third plurality of links and the third plurality of couplers.

Example 45. The adjustable end-of-arm tool of Example 44, wherein the base may have a longitudinal mid-plane. The first adjustable assembly and the third adjustable assembly being positioned on a first side of the longitudinal mid-plane and the second adjustable assembly being positioned on a second side of the longitudinal mid-plane, the second side being opposite the first side.

Example 46. The adjustable end-of-arm tool of Example 45, wherein each of the first adjustable assembly, the second adjustable assembly, and the third adjustable assembly may be independently coupled to the base.

Example 47. An adjustable end-of-arm tool for a robot may comprise a base adapted to be coupled to the robot; a first adjustable assembly coupled to the base; and a second adjustable assembly coupled to the base. The first adjustable assembly may comprise a first linear adjustment subassembly coupled to the base. The first linear adjustment subassembly may provide at least two degrees of linear motion relative to the base. The first adjustable assembly may further comprise a first rotational adjustment subassembly coupled to the base through the first linear subassembly. The first rotational adjustment subassembly may provide at least two degrees of rotational motion relative to the base. The first adjustable assembly may further comprise a first tool coupled to the base through the first rotational subassembly and the first linear subassembly. The first tool including a first interface which is positionable relative to the base in multiple positions based on the first linear adjustment subassembly and the first rotational adjustment subassembly. The second adjustable assembly may be coupled to the base. The second adjustable subassembly may comprise a second linear adjustment subassembly coupled to the base. The second adjustable assembly may further comprise a second rotational adjustment subassembly coupled to the base through the second linear subassembly. The second adjustable assembly may further comprise a second tool. The second tool may be coupled to the base through the second rotational subassembly and the second linear subassembly. The second tool may include a second interface which is positionable relative to the base in multiple positions based on the second linear adjustment subassembly and the second rotational adjustment subassembly.

Example 48. The adjustable end-of-arm tool of Example 47, wherein the first rotational adjustment subassembly may provide at least three degrees of rotational motion relative to the base.

Example 49. The adjustable end-of-arm tool of Example 47, wherein the base may include a linear rail defining a first axis. The first linear adjustment subassembly may include a first plurality of links and a first plurality of couplers coupling the plurality of links and the base. The first plurality of couplers may enable linear movement along the first axis, may enable linear movement along a second axis perpendicular to the first axis, may enable linear movement along a third axis perpendicular to both the first axis and the second axis.

Example 50. The adjustable end-of-arm tool of Example 49, wherein the first rotational adjustment subassembly may provide at least three degrees of rotational motion relative to the linear adjustment subassembly about a fourth axis, a fifth axis, and a sixth axis.

Example 51. The adjustable end-of-arm tool of Example 50, wherein the fourth axis is the first axis, the fifth axis is the second axis, and the sixth axis is the third axis.

Example 52. The adjustable end-of-arm tool of any one of Examples 50 and 51, wherein the fourth axis, the fifth axis, and the sixth axis may intersect at a common point.

Example 53. The adjustable end-of-arm tool of any one of Example 47-52, wherein the first tool and the second tool may each be a single-sided tool.

Example 54. The adjustable end-of-arm tool of Example 53, wherein the single-sided tool is one of: a magnetic gripper; a suction gripper; a pin clamp; or a locator.

Example 55. The adjustable end-of-arm tool of any one of Example 47-52, wherein the first tool and the second tool may each be a double-sided tool.

Example 56. The adjustable end-of-arm tool of any one of Examples 47-55, may further comprise a controller configured to: identify a first configuration associated with a first object; and configure the first adjustable assembly and the second adjustable assembly according to the first configuration to position the first interface of first tool in a first position relative to the base and to position the second interface of the second tool in a second position relative to the base.

Example 57. The adjustable end-of-arm tool of Example 56, wherein the first configuration associated with the first object may identified according to a sequence comprising the first object and a second object. The controller may be further configured to identify a second configuration associated with the second object according to the sequence; and configure the first adjustable assembly and the second adjustable assembly according to the second configuration to position the first interface of first tool in a third position relative to the base and to position the second interface of the second tool in a fourth position relative to the base.

Example 58. The adjustable end-of-arm tool of Example 47, may further comprise a third adjustable assembly coupled to the base. The third adjustable assembly may comprise a third linear adjustment subassembly coupled to the base. The third linear adjustment subassembly may provide at least two degrees of linear motion relative to the base. The third adjustable assembly may further comprise a third rotational adjustment subassembly coupled to the base through the third linear subassembly. The third rotational adjustment subassembly may provide at least two degrees of rotational motion relative to the base. The third tool may be coupled to the base through the third rotational subassembly and the third linear subassembly. The third tool may include a third interface which is positionable relative to the base in multiple positions based on the third linear adjustment subassembly and the third rotational adjustment subassembly.

Example 59. The adjustable end-of-arm tool of Example 58, wherein the base may have a longitudinal mid-plane. The first adjustable assembly and the third adjustable assembly being positioned on a first side of the longitudinal mid-plane and the second adjustable assembly being positioned on a second side of the longitudinal mid-plane, the second side being opposite the first side.

Example 60. The adjustable end-of-arm tool of any one of Examples 58 and 59, wherein the first plurality of links and the first plurality of couplers may provide six degrees of freedom for the positioning the first tool relative to the base, the second plurality of links and the second plurality of couplers may provide six degrees of freedom for the positioning the second tool relative to the base, and the third plurality of links and the third plurality of couplers may provide six degrees of freedom for the positioning the third tool relative to the base.

Example 61. The adjustable end-of-arm tool of Example 60, wherein each of the first adjustable assembly, the second adjustable assembly, and the third adjustable assembly may be independently coupled to the base.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1.-20. (canceled)

21. A method for controlling an adjustable assembly of an EOAT for a robot, the method comprising:
identifying a first configuration associated with a first object;
configuring the adjustable assembly according to the first configuration wherein an interface of the adjustable assembly has a first position relative to a base of the adjustable assembly;
engaging a tool of the adjustable assembly, thereby causing the adjustable assembly to grip the first object;
disengaging the tool of the adjustable assembly;
identifying a second configuration associated with a second object;
configuring the adjustable assembly according to the second configuration wherein an interface of the adjustable assembly has a second position relative to a base of the adjustable assembly, the second position being different than the first position;
engaging the tool of the adjustable assembly, thereby causing the adjustable assembly to grip the second object; and
disengaging the tool of the adjustable assembly.

22. The method of claim 21, wherein:
the first configuration associated with the first object is identified according to a stored sequence comprising the first object and the second object; and
the second configuration associated with the second object is identified according to the stored sequence.

23. The method of claim 21, wherein:
the first configuration associated with the first object is identified in response to detecting the first object using computer vision; and
the second configuration associated with the second object is identified in response to detecting the second object using computer vision.

24. The method of claim 21, wherein configuring the adjustable assembly according to the first configuration comprises:
detecting the first object using computer vision; and
dynamically configuring the adjustable assembly based on the detected first object.

25. The method of claim 21, wherein configuring the adjustable assembly according to the first configuration comprises:
identifying a location of the first object using computer vision; and
configuring the interface of the adjustable assembly according to the identified location.

26. A method for controlling an adjustable assembly of an EOAT for a robot, the adjustable assembly includes a base, a plurality of tools including a first tool having a first interface, a second tool having a second interface, and a third tool having a third interface, the first interface of the first tool being moveable relative to the base in six degrees of freedom, the second interface of the second tool being moveable relative to the base in six degrees of freedom, and the third interface of the third tool being moveable relative to the base in six degrees of freedom, the method comprising:
identifying a first configuration associated with a first object;
configuring the adjustable assembly according to the first configuration wherein the first interface of the first tool of the adjustable assembly has a first position relative to the base, the second interface of the second tool of the adjustable assembly has a second position relative to the base, and the third interface of the third tool of the adjustable assembly has a third position relative to the base;
engaging the plurality of tools of the adjustable assembly, thereby causing the adjustable assembly to grip the first object;
disengaging the plurality of tool of the adjustable assembly;
identifying a second configuration associated with a second object;
configuring the adjustable assembly according to the second configuration wherein at least one of the first interface of the first tool, the second interface of the second tool, and the third interface of the third tool is moved relative to the first configuration;
engaging the plurality of tools of the adjustable assembly, thereby causing the adjustable assembly to grip the second object; and
disengaging the plurality of tools of the adjustable assembly.

27. The method of claim 26, wherein:
the first configuration associated with the first object is identified according to a stored sequence comprising the first object and the second object; and
the second configuration associated with the second object is identified according to the stored sequence.

28. The method of claim 26, wherein:
the first configuration associated with the first object is identified in response to detecting the first object using computer vision; and
the second configuration associated with the second object is identified in response to detecting the second object using computer vision.

29. The method of claim 26, wherein configuring the adjustable assembly according to the first configuration comprises:
detecting the first object using computer vision; and
dynamically configuring the adjustable assembly based on the detected first object.

30. The method of claim 26, wherein configuring the adjustable assembly according to the first configuration comprises:
identifying a location of the first object using computer vision; and
configuring the interface of the adjustable assembly according to the identified location.

31. The method of claim 26, further comprising at least one sensor supported by the adjustable assembly, the controller operable to adjust each of the first tool and the second tool based upon the sensor to prevent a crash between the first tool and the second tool.

32. The method of claim 26, wherein in response to identifying the first configuration of the first object, engaging the plurality of tools of the adjustable assembly comprises:
engaging the first tool in the first position to grip the first object;
engaging the second tool in the second position to grip the first object; and
retracting the third tool relative to the first tool and the second tool to avoid contact with the first tool and the second tool.
